(19) United States
(12) Patent Application Publication
(10) Pub. No.: US 2024/0368727 A1
(43) Pub. Date: Nov. 7, 2024

(54) METHOD OF SELECTIVE PRECIPITATION OF METALS USING AMIDE COMPOUNDS

(71) Applicant: The University Court of the University of Edinburgh, Edinburgh (GB)

(72) Inventors: Jason Love, Edinburgh (GB); Carole Morrison, Edinburgh (GB); Luke Kinsman, Edinburgh (GB); Bryne T. Ngwenya, Edinburgh (GB)

(21) Appl. No.: 18/580,909

(22) PCT Filed: Jul. 21, 2022
(86) PCT No.: PCT/GB2022/051886

§ 371 Date: Jan. 19, 2024

(30) Foreign Application Priority Data
Jul. 26, 2021 (GB) 2110701.6

(51) Int. Cl. C22B 3/44; C22B 3/00; C22B 11/00; C22B 58/00

(52) U.S. Cl. CPC C22B 3/44; C22B 11/04; C22B 25/04; C22B 58/00

(57) ABSTRACT

A method of separating a metal from a solution comprises adding to the solution a compound having a structure represented by Formula (I): wherein: R₁, R₂, R₃ and R₄ are each independently a substituted or unsubstituted aryl group or a substituted or unsubstituted C1-C8 hydrocarbyl group: and Z is a C2-C6 hydrocarbyl group or an aryl group.

### FIELD OF THE INVENTION

The present invention relates to compounds and methods for separating metals. In particular, but not exclusively, the invention relates to compounds and methods for separating and/or precipitating metals, and in particular, gold, from a solution.

### BACKGROUND

Gold is an important metal that is increasingly prevalent in modern technologies such as those found in electronics, catalysis, and medicines due to its chemical and physical properties. Much attention has been paid to the investigation of more efficient recovery and purification of gold due to the environmental and economic burden of recovering this scarce and sparsely distributed metal from primary sources, which requires energy-and emission-intense mining and separation processes. Waste Electrical and Electronic Equipment (WEEE) is a more concentrated source of metals and it is believed that its recycling could partly negate the high global warming potential of gold production. WEEE is recognized as the fastest-growing global waste stream (>5% annual growth) and comprises both critical and hazardous materials for which new separation and recycling technologies are required to provide impetus to global circular economy visions.

Currently, around 90% of the world's gold supply is derived from mining processes that exploit cyanidation. However, the environmental and safety concerns over cyanidation have led to recent studies on alternative leaching and separation methods, including the use of various combinations of oxidizing agents and organic solvents, oxidative mechanochemistry, electrochemical dissolution, and the use of designed chemical reagents for solvent extraction, precipitation, and adsorption. (See (1) Rao, M. D.; Singh, K. K.; Morrison, C. A.; Love, J. B., Challenges and opportunities in the recovery of gold from electronic waste. RSC Adv. 2020, 10, 4300-4309; (2) Love, J. B.; Miguirditchian, M.; Chagnes, A., New Insights into the Recovery of Strategic and Critical Metals by Solvent Extraction: The Effects of Chemistry and the Process on Performance. In Ion Exchange and Solvent Extraction: Changing the Landscape in Solvent Extraction, Moyer, B. A., Ed. CRC Press: 2019; Vol. 23; and (3) Wilson, A. M.; Bailey, P. J.; Tasker, P. A.; Turkington, J. R.; Grant, R. A.; Love, J. B., Solvent extraction: the coordination chemistry behind extractive metallurgy. Chem. Soc. Rev. 2014, 43, 123-134.)

Gold can be precipitated selectively from leached Au scrap comprising Au, Sn, Ag, and Zn using the environmentally benign carbohydrate α-cyclodextrin (α-CD) through a molecular recognition process (see (4) Liu, Z.; Frasconi, M.; Lei, J.; Brown, Z. J.; Zhu, Z.; Cao, D.; Lehl, J.; Liu, G.; Fahrenbach, A. C.; Botros, Y. Y.; Farha, O. K.; Hupp, J. T.; Mirkin, C. A.; Stoddart, J. F., Selective isolation of gold facilitated by second-sphere coordination with α-cyclodextrin. Nat. Commun. 2013, 4, 1855; and also (5) Liu, Z.; Samanta, A.; Lei, J.; Sun, J.; Wang, Y.; Stoddart, J. F., Cation-Dependent Gold Recovery with α-Cyclodextrin Facilitated by Second-Sphere Coordination. J. Am. Chem. Soc. 2016, 138, 11643-11653). In this case, pH adjustment of the HNO₃/HBr leachate using KOH delivered KAuBr₄ which assembled with α-CD into an insoluble superstructure of α-CD/AuBr₄⁻/K(OH₂)₆⁺ nanochannels. Gold was released by an acidic wash which recycled the α-CD for further use.

Similar processes have been reported using cucurbit [n]urils as selective precipitants, in these cases forming a variety of superstructures depending on the cavity size of the cucurbit [n]uril (n=5-8) (see (6) Chen, L.-X.; Liu, M.; Zhang, Y.-Q.; Zhu, Q.-J.; Liu, J.-X.; Zhu, B.-X.; Tao, Z., Outer surface interactions to drive cucurbit [8]uril-based supramolecular frameworks: possible application in gold recovery. Chem. Commun., 2019, 55, 14271-14274; (7) Lin, R.-L.; Dong, Y.-P.; Tang, M.; Liu, Z.; Tao, Z.; Liu, J.-X., Selective Recovery and Detection of Gold with Cucurbit [n]urils (n=5-7). Inorg. Chem. 2020, 59, 3850-3855; and also (8) Wu, H.; Jones, L. O.; Wang, Y.; Shen, D.; Liu, Z.; Zhang, L.; Cai, K.; Jiao, Y.; Stern, C. L.; Schatz, G. C.; Stoddart, J. F., High-Efficiency Gold Recovery Using Cucurbit[6]uril. ACS Appl. Mater. Interfaces 2020, 12, 38768-38777). Similar selectivity to the α-CDs was seen for the precipitation of gold from mixed metal sources (with Cu, Cd, Ni, Zn), and recycling and reuse of the cucurbit[n]uril was achieved after reduction of Au(III) to Au(0).

Pre-formed porous network materials show selectivity for gold adsorption over other metals. A methionine-decorated metal-organic framework (MOF) adsorbed a mixture of Au(III) and Au(I) within its S-decorated pores from an aqueous solution of Au, Pd, Ni, Cu, Zn, and Al (see (9) Mon, M.; Ferrando-Soria, J.; Grancha, T.; Fortea-Pérez, F. R.; Gascon, J.; Leyva-Pérez, A.; Armentano, D.; Pardo, E., Selective Gold Recovery and Catalysis in a Highly Flexible Methionine-Decorated Metal-Organic Framework. J. Am. Chem. Soc. 2016, 138, 7864-7867). Gold was stripped from the MOF using Me₂S and the MOF was reusable. Trace amounts of gold from complex metal mixtures in water were extracted using a combined MOF/redox-active polymer composite to selectively adsorb and reduce gold to its metallic state (see (10) Sun, D. T.; Gasilova, N.; Yang, S.; Oveisi, E.; Queen, W. L., Rapid, Selective Extraction of Trace Amounts of Gold from Complex Water Mixtures with a Metal-Organic Framework (MOF)/Polymer Composite. J. Am. Chem. Soc. 2018, 140, 16697-16703). Calcination and treatment with conc. HCl released the gold in high purity. This material also proved effective for the selective adsorption of Au from an e-waste leachate comprising Au, Ni, and Cu. A porous porphyrin polymer has proved effective for the adsorption/reduction of precious metals from solution, with some selectivity for gold. Adsorption from an e-waste leachate (aqua regia) resulted in 94% gold capture as gold clusters through a photocatalytic reduction mechanism (see (11) Hong, Y.; Thirion, D.; Subramanian, S.; Yoo, M.; Choi, H.; Kim, H. Y.; Stoddart, J. F.; Yavuz, C. T., Precious metal recovery from electronic waste by a porous porphyrin polymer. Proc. Nat. Acad. Sci. 2020, 117, 16174).

Macrocyclic amide receptors have been developed and act as hosts for square-planar precious metalate guest molecules (see (12) Liu, W.; Oliver, A. G.; Smith, B. D., Macrocyclic Receptor for Precious Gold, Platinum, or Palladium Coordination Complexes. J. Am. Chem. Soc. 2018, 140, 6810-6813).

Other work discloses more simple durene-based diamides that were protonated by solutions of HAuCl₄, resulting in the capture and precipitation of HAuCl₄ from aqueous acid as an extended supramolecular amide network (see (13) Smith, B. D.; Shaffer, C. C.; Liu, W.; Oliver, A. G., Supramolecular Paradigm for Capture and Co-Precipitation of Gold(III) Coordination Complexes. Chem. Eur. J. 2020, 27, 751-757). However, no selective capture or precipitation was shown. Extended supramolecular network structures were also formed upon selective precipitation of HAuCl₄ from acidic solutions comprising Au, Ni, Cu, Zn, alkali-, and alkaline-earth metals by the biomolecule niacin, a pyridine carboxylic acid (see Nag, A., Islam, M. R. & Pradeep, T. Selective extraction of gold by niacin. ACS Sustain. Chem. Eng.,2021, 9, 2129-2135).

Selective separation of gold from a solution representative of e-waste using simple primary amides was reported (see (14) Doidge, E. D.; Carson, I.; Tasker, P. A.; Ellis, R. J.; Morrison, C. A.; Love, J. B., A Simple Primary Amide for the Selective Recovery of Gold from Secondary Resources. Angew. Chem. Int. Ed. 2016, 55, 12436-12439; and (15) Doidge, E. D.; Kinsman, L. M. M.; Ji, Y.; Carson, I.; Duffy, A. J.; Kordas, I. A.; Shao, E.; Tasker, P. A.; Ngwenya, B. T.; Morrison, C. A.; Love, J. B., Evaluation of simple amides in the selective recovery of gold from secondary sources by solvent extraction. ACS Sustain. Chem. Eng. 2019, 7, 15019-15029). However, the methods disclosed therein require solvent extraction and do not involve precipitation.

It is an object of the invention to address and/or mitigate one or more problems associated with the prior art.

### Definitions

“Alkyl” as used herein alone or as part of another group, refers to a linear or branched chain hydrocarbon containing from 1 to 20 carbon atoms, which can be referred to as a C1-C20 alkyl. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl, and the like. “Lower alkyl” as used herein, is a subset of alkyl, and, in some embodiments, refers to a linear or branched chain hydrocarbon group containing from 1 to 4 carbon atoms. Representative examples of lower alkyl include, but are not limited to, methyl, ethyl, n-propyl, iso-propyl, n-butyl, iso-butyl, tert-butyl, and the like. The term “alkyl” or “lower alkyl” is intended to include both substituted and unsubstituted alkyl or lower alkyl unless otherwise indicated and these groups may be substituted with groups selected from halo, alkyl, haloalkyl, alkenyl, alkynyl, cycloalkyl, cycloalkylalkyl, aryl, arylalkyl, heterocyclo, heterocycloalkyl, hydroxyl, alkoxy (thereby creating a polyalkoxy such as polyethylene glycol), alkenyloxy, alkynyloxy, haloalkoxy, cycloalkoxy, cycloalkylalkyloxy, aryloxy, arylalkyloxy, heterocyclooxy, heterocycloalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, carboxy, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, acylamino, acyloxy, ester, amide, sulfonamide, urea, alkoxyacylamino, aminoacyloxy, nitro or cyano where m=0, 1, 2 or 3.

“Alkenyl” as used herein alone or as part of another group, refers to a linear or branched chain hydrocarbon containing from 1 to 20 carbon atoms (or in lower alkenyl 1 to 4 carbon atoms) that can include 1 to 8 double bonds in the normal chain, and can be referred to as a C1-C20 alkenyl. Representative examples of alkenyl include, but are not limited to, vinyl, 2-propenyl, 3-butenyl, 2-butenyl, 4-pentenyl, 3-pentenyl, 2-hexenyl, 3-hexenyl, 2,4-heptadiene, and the like. The term “alkenyl” or “lower alkenyl” is intended to include both substituted and unsubstituted alkenyl or lower alkenyl unless otherwise indicated and these groups may be substituted with groups as described in connection with alkyl and lower alkyl above.

“Alkynyl” as used herein alone or as part of another group, refers to a linear or branched chain hydrocarbon containing from 1 to 20 carbon atoms (or in lower alkynyl 1 to 4 carbon atoms) which include 1 triple bond in the normal chain, and can be referred to as a C1-C20 alkynyl. Representative examples of alkynyl include, but are not limited to, 2-propynyl, 3-butynyl, 2-butynyl, 4-pentynyl, 3-pentynyl, and the like. The term “alkynyl” or “lower alkynyl” is intended to include both substituted and unsubstituted alkynyl or lower alkynyl unless otherwise indicated and these groups may be substituted with the same groups as set forth in connection with alkyl and lower alkyl above.

“Halo” as used herein refers to any suitable halogen, including —F, —Cl, —Br, and —I.

“Mercapto” as used herein refers to a —SH group.

“Azido” as used herein refers to a —N₃ group.

“Cyano” as used herein refers to a —CN group.

“Hydroxyl” as used herein refers to an —OH group.

“Nitro” as used herein refers to a —NO₂ group.

“Alkoxy” as used herein alone or as part of another group, refers to an alkyl or lower alkyl group, as defined herein (and thus including substituted versions such as polyalkoxy), appended to the parent molecular moiety through an oxy group, —O—. Representative examples of alkoxy include, but are not limited to, methoxy, ethoxy, propoxy, 2-propoxy, butoxy, tert-butoxy, pentyloxy, hexyloxy and the like.

“Acyl” as used herein alone or as part of another group refers to a —C(O)R radical, where R is any suitable substituent such as aryl, alkyl, alkenyl, alkynyl, cycloalkyl or other suitable substituent as described herein.

“Haloalkyl” as used herein alone or as part of another group, refers to at least one halogen, as defined herein, appended to the parent molecular moiety through an alkyl group, as defined herein. Representative examples of haloalkyl include, but are not limited to, chloromethyl, 2-fluoroethyl, trifluoromethyl, pentafluoroethyl, 2-chloro-3-fluoropentyl, and the like.

“Alkylthio” as used herein alone or as part of another group, refers to an alkyl group, as defined herein, appended to the parent molecular moiety through a thio moiety, as defined herein. Representative examples of alkylthio include, but are not limited, methylthio, ethylthio, tert-butylthio, hexylthio, and the like.

“Cycloalkyl” as used herein alone or as part of another group, refers to a saturated or partially unsaturated cyclic hydrocarbon group containing from 1 to 20 carbon atoms (optionally with a carbon atom replaced in a heterocyclic group as discussed below). A cycloalkyl group may include 0, 1, 2, or more double or triple bonds. Representative examples of cycloalkyl include, cyclopropyl, cyclobutyl, cyclopentyl, cyclohexyl, cycloheptyl, cyclooctyl, and cyclododecyl. These rings may optionally be substituted with additional substituents as described herein such as halo or lower alkyl. The term “cycloalkyl” is generic and intended to include heterocyclic groups as discussed below unless specified otherwise.

“Heterocyclic group” or “heterocyclo” as used herein alone or as part of another group, refers to an aliphatic (e.g., fully or partially saturated heterocyclo) or aromatic (e.g., heteroaryl) monocyclic- or a bicyclic-ring system. Monocyclic ring systems are exemplified by any 5 - or 6-membered ring containing 1, 2, 3, or 4 heteroatoms independently selected from oxygen, nitrogen and sulfur. The 5-membered ring has from 0-2 double bonds and the 6-membered ring has from 0-3 double bonds. Representative examples of monocyclic ring systems include, but are not limited to, azetidine, azepine, aziridine, diazepine, 1,3-dioxolane, dioxane, dithiane, furan, imidazole, imidazoline, imidazolidine, isothiazole, isothiazoline, isothiazolidine, isoxazole, isoxazoline, isoxazolidine, morpholine, oxadiazole, oxadiazoline, oxadiazolidine, oxazole, oxazoline, oxazolidine, piperazine, piperidine, pyran, pyrazine, pyrazole, pyrazoline, pyrazolidine, pyridine, pyrimidine, pyridazine, pyrrole, pyrroline, pyrrolidine, tetrahydrofuran, tetrahydrothiophene, tetrazine, tetrazole, thiadiazole, thiadiazoline, thiadiazolidine, thiazole, thiazoline, thiazolidine, thiophene, thiomorpholine, thiomorpholine sulfone, thiopyran, triazine, triazole, trithiane, and the like. Bicyclic ring systems are exemplified by any of the above monocyclic ring systems fused to an aryl group as defined herein, a cycloalkyl group as defined herein, or another monocyclic ring system as defined herein. Representative examples of bicyclic ring systems include but are not limited to, for example, benzimidazole, benzothiazole, benzothiadiazole, benzothiophene, benzoxadiazole, benzoxazole, benzofuran, benzopyran, benzothiopyran, benzodioxine, 1,3-benzodioxole, cinnoline, indazole, indole, indoline, indolizine, naphthyridine, isobenzofuran, isobenzothiophene, isoindole, isoindoline, isoquinoline, phthalazine, purine, pyranopyridine, quinoline, quinolizine, quinoxaline, quinazoline, tetrahydroisoquinoline, tetrahydroquinoline, thiopyranopyridine, and the like. These rings include quaternized derivatives thereof and may be optionally substituted with groups selected from halo, alkyl, haloalkyl, alkenyl, alkynyl, cycloalkyl, cycloalkylalkyl, aryl, arylalkyl, heterocyclo, heterocycloalkyl, hydroxyl, alkoxy, alkenyloxy, alkynyloxy, haloalkoxy, cycloalkoxy, cycloalkylalkyloxy, aryloxy, arylalkyloxy, heterocyclooxy, heterocycloalkyloxy, mercapto, alkyl-S(O)ₘ, haloalkyl-S(O)ₘ, alkenyl-S(O)ₘ, alkynyl-S(O)ₘ, cycloalkyl-S(O)ₘ, cycloalkylalkyl-S(O)ₘ, aryl-S(O)ₘ, arylalkyl-S(O)ₘ, heterocyclo-S(O)ₘ, heterocycloalkyl-S(O)ₘ, amino, alkylamino, alkenylamino, alkynylamino, haloalkylamino, cycloalkylamino, cycloalkylalkylamino, arylamino, arylalkylamino, heterocycloamino, heterocycloalkylamino, disubstituted-amino, acylamino, acyloxy, ester, amide, sulfonamide, urea, alkoxyacylamino, aminoacyloxy, nitro or cyano where m=0, 1, 2 or 3.

“Aryl” as used herein alone or as part of another group, refers to a monocyclic, carbocyclic ring system or a bicyclic, carbocyclic fused ring system having one or more aromatic rings. Representative examples of aryl include, but are not limited to, azulenyl, indanyl, indenyl, naphthyl, phenyl, tetrahydronaphthyl, and the like. The term “aryl” is intended to include both substituted and unsubstituted aryl unless otherwise indicated and these groups may be substituted with the same groups as set forth in connection with alkyl and lower alkyl above.

“Arylalkyl” as used herein alone or as part of another group, refers to an aryl group, as defined herein, appended to the parent molecular moiety through an alkyl group, as defined herein. Representative examples of arylalkyl include, but are not limited to, benzyl, 2-phenylethyl, 3-phenylpropyl, 2-naphth-2-ylethyl, and the like.

“Amino” as used herein means the radical —NH₂.

“Alkylamino” as used herein alone or as part of another group means the radical —NHR, where R is an alkyl group.

“Ester” as used herein alone or as part of another group refers to a —C(O)OR radical, where R is any suitable substituent such as alkyl, cycloalkyl, alkenyl, alkynyl or aryl.

“Formyl” as used herein refers to a —C(O)H group.

“Carboxylic acid” as used herein refers to a —C(O)OH group.

“Sulfoxyl” as used herein refers to a compound of the formula —S(O)R, where R is any suitable substituent such as alkyl, cycloalkyl, alkenyl, alkynyl or aryl.

“Sulfonyl as used herein refers to a compound of the formula —S(O)(O)R, where R is any suitable substituent such as alkyl, cycloalkyl, alkenyl, alkynyl or aryl.

“Sulfonate” as used herein refers to a salt (e.g., a sodium (Na) salt) of a sulfonic acid and/or a compound of the formula —S(O)(O)OR, where R is any suitable substituent such as alkyl, cycloalkyl, alkenyl, alkynyl or aryl.

“Sulfonic acid as used herein refers to a compound of the formula —S(O)(O)OH.

“Amide” as used herein alone or as part of another group refers to a —C(O)NRₐR_{b} radical, where Rₐ and R_{b} are any suitable substituent such as alkyl, cycloalkyl, alkenyl, alkynyl or aryl.

“Sulfonamide” as used herein alone or as part of another group refers to a —S(O)₂NRₐR_{b} radical, where Rₐ and R_{b} are any suitable substituent such as H, alkyl, cycloalkyl, alkenyl, alkynyl, aryl, heteroalkyl, or heteroaryl.

### SUMMARY

The present invention is based upon the finding that, under certain conditions, it is possible to selectively separate, e.g. precipitate, one or more precious metals, and in particular gold, platinum, tin and/or gallium, from a solution containing a mixture of metals, such as a mixture of precious metals, using a compound described herein.

According to a first aspect, there is provided a method of separating a metal from a solution, the method comprising adding to the solution a compound having a structure represented by Formula (I):

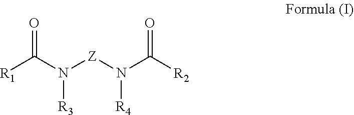

wherein:

R₁, R₂, R₃ and R₄ are each independently a substituted or unsubstituted aryl group, or a substituted or unsubstituted C1-C8 hydrocarbyl group; and

Z is a C2-C6 hydrocarbyl group or an aryl group.

R₁, R₂, R₃ and R₄ may be the same or different.

R₁ and R₂ may be the same or different. Typically, R₁ and R₂ may be the same.

R₃ and R₄ may be the same or different. Typically, R₃ and R₄ may be the same.

R₁ and R₂ may each independently be a substituted or unsubstituted aryl group.

R₃ and R₄ may each independently be a substituted or unsubstituted C1-C8 hydrocarbyl group.

Typically, R₁ and/or R₂ may comprise or may consist of an optionally substituted monoaromatic aryl moiety. Typically, R₁ and/or R₂ may comprise or may consist of an unsubstituted monoaromatic aryl group. For example, R₁ and/or R₂ may be phenyl.

Typically, R₃ and/or R₄ may comprise or may consist of an optionally substituted C1-C8 alkyl group. Typically, R₃ and/or R₄ may be an unsubstituted (linear or branched) C1-C8 alkyl group, optionally an unsubstituted (linear or branched) C1-C4 alkyl group.

Z may be an unsubstituted C2-C6 hydrocarbyl group, such as alkyl, alkenyl, alkynyl, cycloalkyl, aryl, or arylalkyl. Typically, Z may be an unsubstituted C2-C6 alkyl group. Typically, Z may be a linear C2-C6 alkyl group. In an embodiment, Z may be —(CH₂)₂—. Alternatively, Z may be a substituted or unsubstituted aryl group, such as a —(C₆H₄)— group, e.g. —(o-C₆H₄)—, —(m-C₆H₄)—, or —(p-C₆H₄)— preferably —(p-C₆H₄)—.

Advantageously, the inventors have found that the compound having the structure represented by Formula (I) provides both highly selective separation of one or more metals, and in particular gold, platinum tin and/or gallium, from a solution, and also causes effective precipitation of the resulting complex compound out of solution. Further, the present approach does not require the use of any organic solvents, and allows the metal to be stripped from the precipitate, thus allowing recycling and reuse of the compound.

Without being wishing to be bound by theory, it is believed that the provision of a relatively short hydrocarbyl or aryl bridge between the two amide function groups, of a relatively small aryl group as R₁ and/or R₂, and of a relatively small hydrocarbyl group as R₃ and/or R₄ may lead to the unexpected ability of the present compound to bind to certain metal ions, and in particular to gold (Au(III)), to platinum (Pt(IV)), to tin (Sn(IV)) and/or to gallium (Ga(III)), with the resulting complex compound precipitating out of solution. In addition, the compounds have sufficient solubility in an aqueous solution, e.g. in an acidic aqueous solution, to interact with the solubilised metal(s) and trigger separation and precipitation.

Thus, the method may comprise separating the metal from the solution by precipitation.

R₁ and R₂ may each independently be a substituted or unsubstituted phenyl group. In such instance the compound may have a structure represented by Formula (Ia):

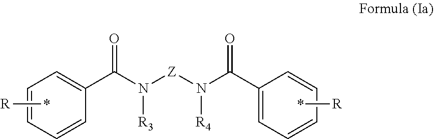

wherein:

R₃ and R₄ are each independently a substituted or unsubstituted aryl group, or a substituted or unsubstituted C1-C8 hydrocarbyl group;

Z is a C2-C6 hydrocarbyl group or an aryl group; and

R are independently H, alkyl, alkoxy, hydroxyl or halogen.

R may be independently provided at the ortho, meta, or para position.

R may be independently provided at the para position. In such instance, the compound may have a structure represented by Formula (Ib):

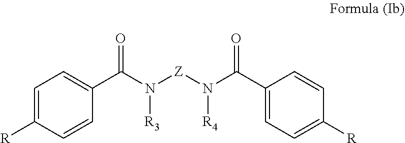

In some embodiments:

R₃ and/or R₄ may be an unsubstituted (linear or branched) C1-C8 alkyl group, optionally an unsubstituted (linear or branched) C1-C4 alkyl group;

Z may be a C2-C6 hydrocarbyl group or an aryl group; and

R may be H, OMe, or a halogen.

The compound may have a structure represented by Formula (II):

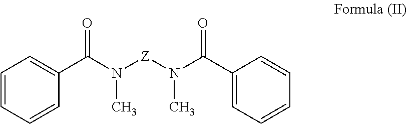

wherein Z is a C2-C6 hydrocarbyl group or an aryl group.

In an embodiment, the compound may have a structure represented by Formula (III):

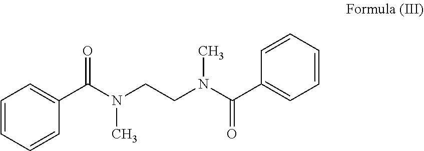 [SMILES: CN(CCN(C)C(=O)c1ccccc1)C(=O)c1ccccc1]

The inventors have found that the particular structure of the compound described herein, for example as represented by Formula (III), provides both highly selective separation of one or more metals, and in particular, gold, platinum, tin and/or gallium, from a solution, and also effective precipitation of the resulting complex compound out of solution.

The solution may comprise one or more metals selected from the list consisting of Au, Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and Zn. The solution may comprise one or more precious metals, e.g. one or more metals selected from the list consisting of gold, platinum, palladium, ruthenium, rhodium, iridium and osmium, preferably gold and/or platinum. The solution may comprise or may further comprise tin and/or gallium. When the metal is provided in solution, the metal may comprise or may consist of one or more metals selected from Au(III), Pt(IV) and/or Sn(IV) and/or Ga(III).

The solution may be an aqueous solution. Typically, the solution may be an aqueous acid solution.

The solution may be an acidic solution of a strong acid, e.g. HCl, HNO₃, or the like. Typically, the solution may be an acidic solution of HCl at a concentration of about 0.1-8 M, e.g. about 1-8 M, e.g. about 2-6 M.

The compound may be added in an amount selected to separate and/or precipitate a particular metal.

The metal may comprise or may consist of one or more metals selected from the list consisting of Au, Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and Zn. The metal may comprise or may be one or more precious metals, e.g. one or more metals selected from the list consisting of gold, platinum, palladium, ruthenium, rhodium, iridium and osmium, preferably gold and/or platinum. The solution may comprise or may further comprise tin and/or gallium.

The inventors have found that the compound shows preferential affinity for gold compared to other metals, such as Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and Zn. Thus, in a mixture of precious metals, e.g. Au, Pt, Pd, Ru, Rh, Ir and Os, the inventors have found that the compound shows preferential affinity for gold compared to other precious metals.

The inventors have also found that the compound shows preferential affinity for platinum compared to other metals, such as Ag, Al, B, Ba, Bi, Ca, Cd, Co, Cr, Cu, Fe, Ga, In, Ir, K, Li, Mg, Mn, Na, Ni, Os, Pb, Rh, Ru, Sn, Sr, Tl, and Zn. Thus, in a mixture of precious metals substantially free of gold, e.g. Pt, Pd, Ru, Rh, Ir and Os, the inventors have found that the compound shows preferential affinity for platinum compared to other precious metals.

The inventors have also found that the compound shows preferential affinity for tin compared to other metals, such as Ag, Al, B, Ba, Bi, Ca, Cd, Co, Cr, Cu, Ga, In, Ir, K, Li, Mg, Mn, Na, Ni, Os, Pb, Rh, Ru, Sr, Tl, and Zn. Thus, in a mixture of metals substantially free of gold, platinum or iron, the inventors have found that the compound shows preferential affinity for tin compared to other metals.

The inventors have also found that the compound shows preferential affinity for gallium compared to other metals, such as Ag, Al, B, Ba, Bi, Ca, Cd, Co, Cr, Cu, In, Ir, K, Li, Mg, Mn, Na, Ni, Os, Pb, Rh, Ru, Sr, Tl, and Zn. Thus, in a mixture of metals substantially free of gold, platinum, iron or tin, the inventors have found that the compound shows preferential affinity for gallium compared to other metals. This may be useful to allow separation of gallium from certain types of metal mixtures, such as separation of gallium from zinc (for example starting from zinc ores) and separation of gallium from indium (for example starting from display screens and/or semiconductors).

The inventors have also found that gold may be selectively separated and/or precipitated at lower concentrations of the compound, whilst it may be possible to separate and/or precipitate, e.g. simultaneously, multiple metals such as Au, Fe, Sn, Pt, Ga and Tl, when adding higher concentrations of the compound. The inventors have also found that, if no gold is present in the solution, platinum may be selectively separated and/or precipitated at lower concentrations of the compound, whilst it may be possible to separate and/or precipitate, e.g. simultaneously, multiple metals such as Fe, Sn, Pt, Ga and Tl, when adding higher concentrations of the compound. The inventors have also found that, if no gold, platinum or iron is present in the solution, tin may be selectively separated and/or precipitated at lower concentrations of the compound, whilst it may be possible to separate and/or precipitate, e.g. simultaneously, multiple metals such as Sn, Ga and Tl, when adding higher concentrations of the compound. The inventors have also found that, if no gold, platinum, iron or tin is present in the solution, gallium may be selectively separated and/or precipitated from a mixture of metals, for example from a mixture of gallium and zinc or from a mixture of gallium and indium.

The method may comprise adding the compound at a molar ratio of about 1:1 to about 2:1 relative to the metal or metals. The method may comprise adding the compound at a stoichiometric or near stoichiometric ratio relative to the metal or metals.

For example, the method may comprise adding the compound at a molar ratio of about 1:1 to about 2:1 relative to gold in the solution. Advantageously, the method may comprise adding the compound at or near a stoichiometric ratio relative to the amount of gold in the solution, e.g. at a ratio of about 1:1 to about 1.1:1. It was found that a stoichiometric amount of compound may cause selective separation and/or precipitation of gold from the solution, but without or with minimal co-precipitation (typically less than about 5%) of other metals.

In another example, the method may comprise adding the compound at a molar ratio of about 2:1 relative to platinum in the solution.

It will be appreciated that the exact amount of the compound added to cause selective separation and/or precipitation of gold and/or platinum, may depend on the concentration of the acid, e.g. HCl, in the solution.

For example, if the concentration of the acid, e.g. HCl, in the solution, is relatively low, e.g. about 0.1-1 M, the method may comprise adding the compound at a molar ratio of about 1:1 to about 2:1 relative to gold in the solution. If the concentration of the acid, e.g. HCl, in the solution, is relatively high, e.g. about 2-8 M, the method may comprise adding the compound at or near a stoichiometric ratio relative to the amount of gold in the solution, e.g. at a ratio of about 1:1 to about 1.1:1 relative to gold in the solution.

The inventors have found that, for a solution containing gold and platinum, if the concentration of the acid, e.g. HCl, in the solution, is relatively low, e.g. about 0.1-2 M, addition of the compound leads to selective separation, e.g. precipitation, of gold, even with an excess amount of compound (i.e. even with a molar ratio of compound in excess of 1:1 relative to gold). However, If the concentration of the acid, e.g. HCl, in the solution, is relatively high, e.g. about 2 M-8 M, in particular at least about 6 M, e.g. about 6-8 M, addition of the compound leads to co-precipitation of gold and platinum.

The method may comprise adding the compound in excess amount (e.g. greater than a stoichiometric amount) relative to the metal or metals. For example, the method may comprise adding the compound in a molar ratio of at least 2:1, e.g. at least 5:1, e.g. at least 10:1, relative to the metal or metals. It was found that an excess amount of compound relative to one or more metals, preferably relative to each metal of interest (such as gold, iron, tin, platinum, and/or thallium), may cause precipitation, e.g. simultaneous or co-precipitation, of the metals.

Thus, in an embodiment, the method may comprise measuring the concentration in the solution of one or more metals, typically of gold, Ag, Al, B, Ba, Bi, Ca, Cd, Co, Cr, Cu, Fe, Ga, In, Ir K, Li, Mg, Mn, Na, Ni, Os, Pb, Pt, Rh, Ru, Sn, Sr, Tl, and/or Zn. Typically, the method may comprise measuring the concentration of gold, platinum, tin and/or gallium in the solution. The method may further comprise measuring the concentration in the solution of one or more additional metals selected from Ag, Al, B, Ba, Bi, Ca, Cd, Co, Cr, Cu, Fe, In, Ir K, Li, Mg, Mn, Na, Ni, Os, Pb, Rh, Ru, Sr, Tl, and/or Zn.

When selective precipitation of gold is desired, the method may comprise adding the compound at a molar ratio of about 1:1 to about 2:1 relative to gold in the solution, e.g. at or near a stoichiometric ratio relative to the amount of gold in the solution, e.g. at a ratio of about 1:1 to about 1.1:1. This may be particularly useful if the concentration of other metals such as Ag, Al, B, Ba, Bi, Ca, Cd, Co, Cr, Cu, Fe, Ga, In, Ir K, Li, Mg, Mn, Na, Ni, Os, Pb, Pt, Rh, Ru, Sn, Sr, Tl, and/or Zn, is greater than the concentration of gold in the solution, as gold will be selectively precipitated.

When co-precipitation is desired, the method may comprise adding the compound in an excess amount relative to one or more metals, preferably in an excess amount relative to each of the metal or metals of interest such as gold, Ag, Al, B, Ba, Bi, Ca, Cd, Co, Cr, Cu, Fe, Ga, In, Ir K, Li, Mg, Mn, Na, Ni, Os, Pb, Pt, Rh, Ru, Sn, Sr, Tl, and/or Zn. By such provision, co-precipitation of the metals of interest may be achieved.

As mentioned above, the solution may be an acidic solution of a strong acid, e.g. HCl, HNO₃, aqua regia, or the like. Typically, the solution may be an acidic solution of HCl at a concentration of about 0.1-8 M, e.g. about 1-8 M, e.g. about 2-6 M.

The method may comprise adjusting the concentration of the acid, e.g. HCl, in the solution, to a predetermined level.

The method may comprise adjusting the concentration of the acid, e.g. HCl, in the solution, to about 0.1-8 M, e.g. about 1-8 M, e.g. to about 2-6 M.

When selective precipitation of gold is desired, the method may comprise adjusting the concentration of the acid, e.g. HCl, in the solution, to about 0.1-4 M, e.g. to about 0.1-3 M, e.g. to about 1-3 M, e.g. to about 2-3 M. It was found that, for a concentration of the compound sufficient to extract and/or precipitate multiple metals including gold and other metals (e.g. other precious metals), a lower acid concentration may cause selective separation and/or precipitation of gold from the solution but without or with minimal co-precipitation (typically less than about 5%) of other metals.

When co-precipitation is desired, the method may comprise adjusting the concentration of the acid, e.g. HCl, in the solution, to at least 4 M, e.g. about 4-8 M, e.g. to about 5-6 M or to at least 6 M. It was found that, for a concentration of the compound sufficient to extract and/or precipitate multiple metals including gold and other metals, a higher acid concentration may cause separation and/or co-precipitation of the metals.

When selective co-precipitation of gold and platinum is desired, the method may comprise adjusting the concentration of the acid, e.g. HCl, in the solution, to about 6-8 M, e.g. to at least 6 M, and adding an amount of the compound sufficient to separate and/or precipitate gold and platinum, preferably an amount of the compound being one equivalent (substantially stoichiometric amount) relative to gold and two equivalents relative to platinum. This may lead to selective co-precipitation of gold and platinum from a solution containing gold, platinum, and other metals, e.g. other precious metals.

When a co-precipitate of gold and one other metal is obtained, the method may comprise stripping gold and/or the one or more other metals from the co-precipitate.

Advantageously, the method may comprise sequentially stripping one or more other metals and gold from the co-precipitate, typically sequentially stripping one or more other metals, then gold, from the co-precipitate.

The method may comprise removing the co-precipitate from the solution.

The method may comprise washing the co-precipitate in an aqueous acidic solution, e.g. 2 M HCl, so as to strip one or more other metals from the co-precipitate and yield a gold-containing precipitate.

The method may comprise removing the gold-containing precipitate from the solution.

The method may comprise washing the gold-containing precipitate in water, e.g. deionised water, so as to strip gold from the gold-containing precipitate.

According to a second aspect of the present invention there is provided a method of selectively separating gold from a solution containing gold and one or more other metals, the method comprising adding to the solution a compound having a structure represented by Formula (I):

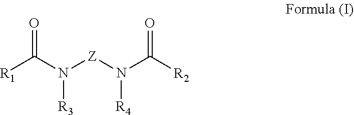

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

wherein the compound is added in a molar ratio of about 1:1 to about 2:1 relative to gold.

Typically, the compound may be added in a molar ratio of about 1:1 to about 1.1:1, e.g. in a substantially stoichiometric ratio, relative to gold. By such provision, a minimal amount of the compound may be used, whilst still yielding selective and maximum precipitation of gold. It will be appreciated that the exact amount of the compound added to cause selective separation and/or precipitation of gold, may depend on the concentration of the acid, e.g. HCl, in the solution. For example, if the concentration of the acid, e.g. HCl, in the solution, is relatively low, e.g. about 0.1-1 M, the method may comprise adding the compound at a molar ratio of about 1:1 to about 2:1 relative to gold in the solution. If the concentration of the acid, e.g. HCl, in the solution, is relatively high, e.g. about 2-8 M, the method may comprise adding the compound at or near a stoichiometric ratio relative to the amount of gold in the solution, e.g. at a ratio of about 1:1 to about 1.1:1 relative to gold in the solution.

Typically, the one or more other metals may be selected from the list consisting of Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and/or Zn. The one or more other metals may comprise one or more precious metals, e.g. one or more metals selected from the list consisting of platinum, palladium, ruthenium, rhodium, iridium and osmium. The one or more other metals may comprise or may further comprise tin and/or gallium.

According to a third aspect there is provided a method of selectively separating gold from a solution containing gold and one or more other metals, wherein the solution is an aqueous solution of a strong acid at a concentration of about 0.1-4 M, wherein the method comprises adding to the solution a compound having a structure represented by Formula (I):

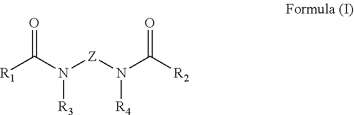

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group.

Typically, the solution may be an aqueous solution of a strong acid at a concentration of about 0.1-3 M, e.g. about 1-3 M, e.g. about 2-3 M. It was found that, for an amount of the compound sufficient to extract and/or precipitate multiple metals including gold and other metals, a lower acid concentration may cause selective separation and/or precipitation of gold from the solution but without or with minimal co-precipitation (typically less than about 5%) of other metals.

Typically, the one or more other metals may be selected from the list consisting of Au, Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and Zn, e.g. iron, tin, platinum, and/or thallium. The one or more other metals may comprise one or more precious metals, e.g. one or more metals selected from the list consisting of platinum, palladium, ruthenium, rhodium, iridium and osmium. The one or more other metals may comprise or may further comprise tin and/or gallium.

As mentioned above, the inventors have found that the present compounds show preferential affinity for gold compared to other metals, such as other precious metals. The inventors have also found that gold may be selectively separated and/or precipitated from the solution at a given concentration of the compound, when the concentration of the acid, e.g. HCl, in the solution, is maintained below a predetermined level, e.g. is about 0.1-4 M, e.g. about 0.1-3 M, e.g. about 1-3 M, e.g. about 2-3 M.

As a result, the inventors have identified methods of sequentially separating gold, and one or more other metals, from a solution containing gold and one or more metals.

According to a fourth aspect there is provided a method of sequentially separating gold, and one or more other metals, from a solution containing gold and one or more other metals, the method comprising:

(i) adding to the solution a compound having a structure represented by Formula

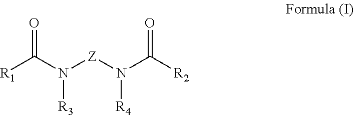

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

wherein the compound is added in a molar ratio of about 1:1 to about 2:1 relative to gold, so as for form a first precipitate comprising gold;

(ii) separating the first precipitate from the solution; and

(iii) adding the compound to the solution in a molar ratio of at least 2:1, e.g. at least 5:1, e.g. at least 10:1, relative to the one or more other metals so as to form a second precipitate comprising the one or more other metals.

The amount of compound added in step (iii) may be greater than the amount of compound added in step (i).

Typically, step (i) may comprise adding the compound in a molar ratio of about 1:1 to about 1.1:1, e.g. in a substantially stoichiometric ration, relative to gold. By such provision, a minimal amount of the compound may be used, whilst still yielding selective and maximum precipitation of gold in the first step.

Typically, step (iii) comprises adding the compound in a molar ratio of at least 5:1, e.g. at least 10:1, relative to the one or more other metals.

Typically, the method may comprise (iv) separating the second precipitate from the solution.

The method may further comprise retrieving gold from the first precipitate, e.g. by washing with an aqueous solution, e.g. water or deionised water.

The method may further comprise retrieving the one or more other metals from the second precipitate, e.g. by washing with an aqueous solution, e.g. an aqueous acidic solution such as a 2 M hydrochloric solution.

Typically, the one or more other metals may be selected from the list consisting of Au, Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and Zn, e.g. iron, tin, platinum, and/or thallium. The one or more other metals may comprise one or more precious metals, e.g. one or more metals selected from the list consisting of platinum, palladium, ruthenium, rhodium, iridium and osmium. The one or more other metals may comprise or may further comprise tin and/or gallium.

According to a fifth aspect there is provided a method of sequentially separating gold, and one or more other metals, from a solution containing gold and one or more other metals, wherein the solution is an aqueous solution of a strong acid at a concentration of about 0.1-4 M, the method comprising:

(i) adding to the solution a compound having a structure represented by Formula (I):

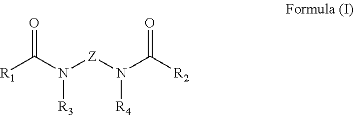

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

so as for form a first precipitate comprising gold;

(ii) separating the first precipitate from the solution; and

(iii) adjusting the concentration of the acid, e.g. HCl, in the solution, to about 4-8 M, so as for form a second precipitate comprising the one or more other metals.

The acidity of the solution in step (iii) may be greater than the acidity pf the solution in step (i).

Step (iii) may comprise adjusting the concentration of the acid, e.g. HCl, in the solution, to at least 4 M, e.g. about 4-8 M, e.g. to at least 6M.

Typically, the method may comprise adding the compound in an excess amount relative to one or more metals, preferably in an excess amount relative to all of the metal or metals of interest such as Au, Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and/or Zn, e.g. gold, platinum, palladium, ruthenium, rhodium, iridium, osmium, tin and/or gallium, preferably gold, platinum, tin and/or gallium. By such provision, sequential precipitation of all metals, based on adjustment of the amount of acid in the solution, may be achieved.

Typically, the method may comprise (iv) separating the second precipitate from the solution.

The method may further comprise retrieving gold from the first precipitate, e.g. by washing with an aqueous solution, e.g. water or deionised water.

The method may further comprise retrieving the one or more other metals from the second precipitate, e.g. by washing with an aqueous solution, e.g. an aqueous acidic solution such as a 2 M hydrochloric solution.

Typically, the one or more other metals may be selected from the list consisting of Au, Ag, Al, B, Ba, Bi, Ca, Cd, Co, Cr, Cu, Fe, Ga, In, Ir, K, Li, Mg, Mn, Na, Ni, Os, Pb, Pt, Rh, Ru, Sn, Sr, Tl, and Zn. The one or more other metals may comprise one or more precious metals, e.g. one or more metals selected from the list consisting of platinum, palladium, ruthenium, rhodium, iridium and osmium. The one or more other metals may comprise or may further comprise tin and/or gallium.

According to a sixth aspect there is provided a method of sequentially separating, from an acidic solution containing gold and one or more other metals, the one or more other metals, then gold, the method comprising:

(i) adding to the solution a compound having a structure represented by Formula (I):

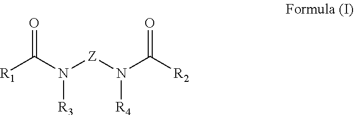

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

so as to form a co-precipitate comprising gold and one or more other metals;

(ii) washing the co-precipitate in an aqueous acidic solution so as to strip the one or more other metals from the co-precipitate and yield a third precipitate; and

(iii) washing the third precipitate in deionised water so as to strip gold from the third precipitate.

Preferably, the amount of the compound, e.g. in step (i), may be an excess amount (e.g. greater than a stoichiometric amount, typically in a molar ratio of at least 2:1, e.g. at least 5:1, e.g. at least 10:1) relative to the metals. Preferably also, the concentration of the acid, e.g. HCl, in the solution, e.g. in step (i), may be about 4-8 M, e.g. about 5-6 M. By such provision, co-precipitation of gold and of the one or more other metals, in step (i), may be achieved.

The method may comprise, between steps (i) and (ii):

(ib) removing the co-precipitate from the solution.

The method may comprise, between steps (ii) and (iii):

(iib) removing the third precipitate from the solution.

As mentioned above, the inventors have found that the particular structure of the compound described herein provides both highly selective separation of gold and/or platinum, from a solution containing gold and/or platinum, and one or more other metals, e.g. one or more other precious metals (such as palladium, ruthenium, rhodium, iridium and/or osmium). The inventors have also found that, if no gold, platinum or iron is present in the solution, the particular structure of the compound described herein provides highly selective separation of tin, from a solution containing tin and one or more other metals.

Thus, according to a seventh aspect there is provided a method of separating gold and platinum from a solution containing gold, platinum and one or more other metals, the method comprising adding to the solution a compound having a structure represented by Formula (I):

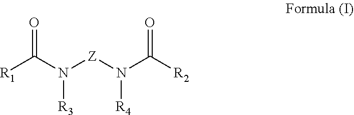

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

wherein the solution is an aqueous solution of a strong acid at a concentration of at least 6 M.

The inventors have found that, for a solution containing gold and platinum, if the concentration of the acid, e.g. HCl, in the solution, is relatively high, e.g. at least 6 M, e.g. about 6-8 M, addition of the compound leads to selective co-precipitation of gold and platinum over one or more other metals, e.g. one or more other precious metals (such as palladium, ruthenium, rhodium, iridium and/or osmium).

The compound may be added in an amount sufficient to separate and/or precipitate gold and platinum, preferably an amount of the compound being one equivalent (substantially stoichiometric amount) relative to gold and two equivalents relative to platinum. This may lead to selective co-precipitation of gold and platinum from a solution containing gold, platinum, and other metals, e.g. other precious metals.

Typically, the one or more other metals may be selected from the list consisting of Ag, Al, B, Ba, Bi, Ca, Cd, Co, Cr, Cu, Fe, Ga, In, Ir, K, Li, Mg, Mn, Na, Ni, Os, Pb, Rh, Ru, Sn, Sr, Tl, and/or Zn. The one or more other metals may comprise one or more precious metals, e.g. one or more metals selected from the list consisting of palladium, ruthenium, rhodium, iridium and osmium. The one or more other metals may comprise or may further comprise tin and/or gallium.

As mentioned above, the inventors have also found that the particular structure of the compound described herein provides both highly selective separation of platinum, from a solution containing platinum and one or more other metals, e.g. one or more other precious metals (such as palladium, ruthenium, rhodium, iridium and/or osmium), when the metal mixture is substantially free of gold. Thus, in a mixture of precious metals substantially free of gold, e.g. Pt, Pd, Ru, Rh, Ir and Os, the inventors have found that the compound shows preferential affinity for platinum compared to other precious metals.

Thus, according to an eighth aspect, there is provided a method of separating platinum from a solution containing platinum and one or more other precious metals, the solution being substantially free of gold, the method comprising adding to the solution a compound having a structure represented by Formula (I):

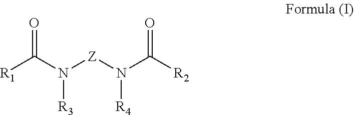

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

wherein the solution is an aqueous solution of a strong acid at a concentration of at least 6 M.

The concentration of the acid, e.g. HCl, in the solution, may be about 6-8 M. The inventors have found that precipitation of platinum is permitted when the concentration of the acid, e.g. HCl, in the solution, is relatively high, e.g. at least about 6 M.

The compound may be added in an amount sufficient to separate and/or precipitate platinum, preferably an amount of the compound being at least two equivalents relative to platinum.

Typically, the one or more other precious metals may be selected from the list consisting of palladium, ruthenium, rhodium, iridium and osmium.

As mentioned above, the inventors have also found that the particular structure of the compound described herein provides both highly selective separation of tin, from a solution containing tin and one or more other metals, when the metal mixture is substantially free of gold, platinum or iron. Thus, in a mixture of metals substantially free of gold, platinum and iron, e.g. a mixture of Ag, Al, B, Ba, Bi, Ca, Cd, Co, Cr, Cu, Ga, In, Ir K, Li, Mg, Mn, Na, Ni, Os, Pb, Rh, Ru, Sn, Sr, Tl, and/or Zn, the inventors have found that the compound shows preferential affinity for tin compared to other metals.

Thus, according to a ninth aspect, there is provided a method of separating tin from a solution containing tin and one or more other metals, the solution being substantially free of gold, platinum and iron, the method comprising adding to the solution a compound having a structure represented by Formula (I):

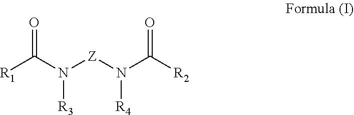

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

wherein the solution is an aqueous solution of a strong acid at a concentration of at least 6 M.

The concentration of the acid, e.g. HCl, in the solution, may be about 6-8 M. The inventors have found that precipitation of tin is permitted when the concentration of the acid, e.g. HCl, in the solution, is relatively high, e.g. at least about 6 M.

The compound may be added in an amount sufficient to separate and/or precipitate tin, preferably an amount of the compound being at least two equivalents relative to tin.

Typically, the one or more other metals may be selected from the list consisting of Ag, Al, B, Ba, Bi, Ca, Cd, Co, Cr, Cu, Ga, In, Ir K, Li, Mg, Mn, Na, Ni, Os, Pb, Rh, Ru, Sr, Tl, and/or Zn.

As mentioned above, the inventors have also found that the particular structure of the compound described herein provides both highly selective separation of gallium, from a solution containing gallium and one or more other metals, when the metal mixture is substantially free of gold, platinum, iron or tin. Thus, in a mixture of metals substantially free of gold, platinum, iron and tin, e.g. a mixture of Ag, Al, B, Ba, Bi, Ca, Cd, Co, Cr, Cu, Ga, In, Ir, K, Li, Mg, Mn, Na, Ni, Os, Pb, Rh, Ru, Sr, Tl, and/or Zn, the inventors have found that the compound shows preferential affinity for gallium compared to other metals. This may be useful to allow separation of gallium from certain types of metal mixtures, such as separation of gallium from zinc (for example starting from zinc ores) and separation of gallium from indium (for example starting from display screens and/or semiconductors).

Thus, according to a tenth aspect, there is provided a method of separating gallium from a solution containing gallium and one or more other metals, the solution being substantially free of gold, platinum, iron and tin, the method comprising adding to the solution a compound having a structure represented by Formula (I):

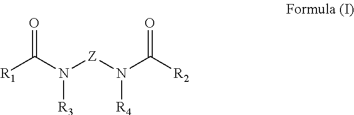

wherein:

R₁, R₂, R₃ and R₄ are each independently a substituted or unsubstituted aryl group or a substituted or unsubstituted C1-C8 hydrocarbyl group; and

Z is a C2-C6 hydrocarbyl group or an aryl group,

wherein the solution is an aqueous solution of a strong acid at a concentration of at least 6 M.

The concentration of the acid, e.g. HCl, in the solution, may be about 6-8 M. The inventors have found that precipitation of gallium is permitted when the concentration of the acid, e.g. HCl, in the solution, is relatively high, e.g. at least about 6 M.

The compound may be added in an amount sufficient to separate and/or precipitate gallium, preferably an amount of the compound being at least one equivalent relative to gallium.

Typically, the one or more other metals may be selected from the list consisting of Ag, Al, B, Ba, Bi, Ca, Cd, Co, Cr, Cu, Ga, In, Ir K, Li, Mg, Mn, Na, Ni, Os, Pb, Rh, Ru, Sr, Tl, and/or Zn. In particular, the one or more other metals may comprise zinc and/or indium.

It will be understood that the features described in respect of any aspect may be equally applicable in relation to any other aspect of the invention, and are not repeated merely for brevity.

### BRIEF DESCRIPTION OF DRAWINGS

Embodiments of the present disclosure will now be given by way of example only, and with reference to the accompanying drawings, which are:

FIG. 1 Schematic representation of a selective precipitation process according to an embodiment, using compound “L”;

FIG. 2 Graph showing percentage metal(s) removed by precipitation from a 0.01 M mixed-metal solution in 2 M or 6 M HCl following the addition of either 0.2 mmol of compound L (10-fold excess L relative to metal) or 0.02 mmol of L (equimolar);

FIG. 3 Graph illustrating a selective metal precipitation and stripping sequence.

FIG. 4 Graph illustrating the selectivity for gold in the presence of 28 other elements from ICP-MS standard solutions;

FIG. 5 X-ray crystal structure of [HL][AuCl₄] showing the intermolecular proton-chelate structure and the arrangement of the AuCl₄⁻ anions within the rhombohedral clefts derived from the phenyl and methyl substituents of the infinite chain of protonated diamides;

FIG. 6 X-ray crystal structure of [HL][H₃O(H₂O)₂][CoCl₄] showing the intermolecular proton-chelate structure and the layered arrangement of the CoCl₄²⁻ anions and H₃O⁺ water cluster between the infinite ribbon chain of protonated diamides;

FIG. 7 Percentage of gold precipitated from 2, 4 or 6 M HCl solutions of 0.01 M HAuCl₄ over time (conditions: 0.02 mmol L stirred at 500 rpm with 2 mL HAuCl₄ in 2, 4 or 6 M HCl at 20° C.);

FIG. 8 Percentage of gold precipitated from 0-2 M HCl solutions of 0.01 M HAuCl₄ (conditions: 0.02 mmol L stirred at 500 rpm with 2 mL HAuCl₄ in 0-2 M HCl solutions for 1 h at 20° C.);

FIG. 9 Percentage of gold precipitated after 5 minutes from 2 M HCl solutions of 0.005 M HAuCl₄ at varying temperatures (conditions: 0.02 mmol L stirred at 500 rpm with 2 mL HAuCl₄ in 2 M HCl solutions for 5 minutes at 20, 40, and 80° C.);

FIG. 10 Graph showing percentage metal(s) removed by precipitation from a 0.01 M mixed-metal solution of precious metals in 6 M HCl following the addition of either 0.2 mmol of compound L (10-fold excess L relative to metal) or 0.02 mmol of L (equimolar);

FIGS. 11-13 Percentage of metal precipitated from solutions of 0.02 M metal salt at different HCl concentrations, for three different compound variants;

FIGS. 14-18 Percentage of metal precipitated from solutions of 0.02 M metal salt at different HCl concentrations, for three different compound variants, for each metal;

FIGS. 19-20 show the effect of the length of the linker group between the two amide groups, in an embodiment of the compound;

FIGS. 21-22 show the effect of the use of an aryl linker group between the two amide groups, in an embodiment of the compound;

FIGS. 23-24 show the effect of changing the substituent group on the nitrogen atoms of the two amide groups, in an embodiment of the compound;

FIGS. 25(a)-(c) show alternative embodiments of the compound.

### DETAILED DESCRIPTION

### Methods and Compounds

All solvents and reagents were used as received from Sigma-Aldrich, Fisher Scientific UK, Alfa Aesar, Acros Organics or VWR International. Deionised water was obtained from a MilliQ purification system.

The exemplary compound used herein (compound “L”) was prepared according to the method described in Kaufmann, L. et al. Substituent effects on axle binding in amide pseudorotaxanes: comparison of NMR titration and ITC data with DFT calculations. Org. Biomol. Chem., 2012, 10, 5954-5964.

Compound L was the compound of Formula (III):

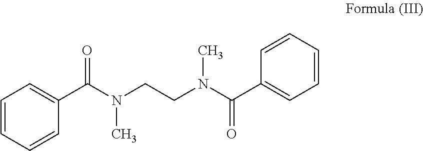 [SMILES: CN(CCN(C)C(=O)c1ccccc1)C(=O)c1ccccc1]

### Precipitation Procedure for 0.01 M Mixed Metal Solutions

Hydrochloric acid solutions (2 M and 6 M) were prepared by dilution of concentrated hydrochloric acid with deionised water. Mixed-metal solutions (0.01 M) were typically prepared by dilution of 0.1 M stock solutions of each individual metal salt solution in 2 or 6 M HCl.

Solid compound L (0.2 mmol or 0.02 mmol) was added to a vial with a magnetic stir bar and the metal-containing aqueous solution (2 mL) added. The mixture was stirred for 1 hour at room temperature (20° C.) at 500 rpm after which the stir bar was removed and the vial centrifuged. The supernatant was decanted and samples prepared for ICP-OES analysis to measure the uptake of metal by L. Samples were diluted by 100× in 2% nitric acid prior to ICP-OES analysis. This procedure was repeated in triplicate.

### Selective Precipitation of Gold from 28 Other Elements Procedure

The following ICP multi-element standard solutions were used: Transition metal mix 3 for ICP supplied by Sigma Aldrich comprising 100 mg L⁻¹ Au, Ir, Os, Pd, Pt, Rh, Ru in 10% hydrochloric acid and ICP multi-element standard solution IV comprising 1000 mg L⁻¹ Ag, Al, B, Ba, Bi, Ca, Cd, Co, Cr, Cu, Fe, Ga, In, K, Li, Mg, Mn, Na, Ni, Pb, Sr, Tl, Zn in dilute nitric acid.

Each solution (1 mL) was diluted to 10 mL using either 2 M HCl or 6 M HCl, resulting in solutions of 10 ppm Au, Ir, Os, Pd, Pt, Rh, Ru and 100 mg L⁻Al, B, Ba, Bi, Ca, Cd, Co, Cr, Cu, Fe, Ga, In, K, Li, Mg, Mn, Na, Ni, Pb, Sr, Tl, Zn. The solutions were filtered prior to use in precipitation experiments due to the precipitation of silver chloride, which was subsequently excluded from ICP-OES analysis. The precipitation method used for the 0.01 M mixed-metal solutions was followed.

### Selective Precipitation of Gold from Waste Printed Circuit Boards

End-of-life printed circuit boards were supplied by Edinburgh School of Chemistry workshop. Gold-tipped sections of the circuit boards (22.85 g) were cut off and soaked in 100 mL aqua regia for 24 hours. This solution was then diluted with deionised water to 250 mL and the metal content analysed by ICP-OES.

An aliquot of the e-waste solution (2 mL) was stirred with L (0.0059 g, 0.02 mmol, excess with respect to the gold concentration) for 1 hour at room temperature after which the stir bar was removed and the vial centrifuged. The supernatant was decanted and samples prepared for ICP-OES analysis to measure the uptake of metal. Samples were diluted by 1000× and 20× in 2% nitric acid prior to ICP-OES analysis. This procedure was repeated in triplicate.

### Crystallisation Procedures

[HL][AuCl₄]: Light yellow prisms were grown at RT from a 0.01 M solution of HAuCl₄ in 2 M HCl layered on a 0.1 M solution of L in chloroform. [HL][H₃O(H₂O)₂][CoCl₄]: Translucent dark blue plates were grown at RT from a mixture of 0.01 M CoCl₂ and L in 10 M HCl.

### Timed Gold Precipitation Experiments

Solutions of HAuCl₄ (0.01 M) were prepared in 2, 4 or 6 M HCl.

Solid L (0.02 mmol) was added to a vial with a magnetic stir bar and the relevant aqueous metal solution (2 mL) was added. The mixture was stirred for between 1 minute* and 55 minutes after which the stir bar is removed and the vial centrifuged for 5 minutes. The supernatant was decanted and samples prepared for ICP-OES analysis to measure the uptake of metal. Samples were diluted by 100× in 2% nitric acid prior to ICP-OES analysis.

*One-minute experiments were not centrifuged and instead stirred for 30 seconds before removing the stir bar and allowing any solids to settle for an additional 30 s. A clear 0.1 mL aliquot was then sampled immediately and prepared for ICP-OES analysis.

### Quantitative NMR Solubility Experiments

¹H NMR spectra were recorded on a Bruker Avance III 400 MHz spectrometer. 2 M and 6 M HCl solutions were diluted from concentrated HCl in D₂O. A 0.1 M solution of L in 2 M or 6 M HCl was prepared by adding L (0.0178 g) to an NMR tube along with the relevant HCl/D₂O solution (0.55 mL) and 1 M tert-butanol in D₂O (0.05 mL) as an internal standard. Any undissolved solids were allowed to settle to the bottom of the NMR tube before acquiring ¹H NMR spectra.

¹H NMR spectra were acquired for 2 M HCl solutions between 300-350 K in 10 K increments and for 6 M HCl solutions between 300-330 K in 10 K increments; attempts to acquire additional spectra beyond 330 K for these latter samples were unsuccessful due to excessive line broadening of the spectra and difficulties with sample locking.

### Selective Stripping Experiments with H-Tube Apparatus

Solid L (0.2 mmol) was added to one side of the H-tube with a stir bar. The metal-containing aqueous solution (2 mL) was then added to the solids and the mixture stirred for 1 hour at room temperature at 500 rpm, after which it was passed through the glass frit of the H-tube with the aid of compressed air or N₂ gas. The filtrate was collected for ICP-OES analysis to determine metal uptake. The solids were subsequently washed with 2 M HCl (3×2 mL) for 30 mins, with each 2 mL solution being passed through the glass frit of the H-tube. The solids were then washed with ultrapure deionised water (5×2 mL) in the same manner. The use of a H-tube allows for all solids to be retained in the same vessel to minimise any loss of metal due to material transfer. This procedure was repeated in duplicate.

### ICP-OES Analysis

ICP-OES analysis was carried out on a Perkin Elmer Optima 5300DC Inductively Coupled Plasma Optical Emission Spectrometer. Samples in 2% nitric acid were taken up by a peristaltic pump at a rate of 1.3 mL min⁻¹ into a Gem Tip cross-flow nebulizer and a glass cyclonic spray chamber. Argon plasma conditions were 1500 W RF forward power and argon gas flows of 12, 1.0, and 0.6 L min⁻¹ for plasma, auxiliary, and nebulizer flow, respectively. ICP-OES calibration standards were obtained from VWR International, Merck Millipore, or Sigma-Aldrich. Selected emission wavelengths are detailed in the supplementary information. Data are rounded to 3 significant figures after incorporating the appropriate dilution factors (typically 100× unless otherwise stated).

### X-Ray Crystallography

X-ray crystallographic data were collected at 100 K or 120 K on an Oxford Diffraction Excalibur diffractometer using graphite monochromated Mo—K_{α} radiation equipped with an Eos CCD detector (λ=0.71073 Å), or at 100 K or 120 K on a Supernova, Dual, Cu at Zero Atlas diffractometer using Cu—K_{α} radiation (λ=1.5418 Å), or at 100 K on a Bruker APEX-II CCD diffractometer using graphite monochromated Mo—K_{α} radiation (λ=0.71073 Å). Structures were solved using ShelXT direct methods or intrinsic phasing and refined using a full-matrix least-square refinement on |F|² using ShelXL. All programs were used within the Olex suites. All non-hydrogen atoms were refined with anisotropic displacement parameters. H-atom parameters were constrained to parent atoms and refined using a riding model except H1 and H2, which were located in the difference Fourier maps and refined with isotropic displacement parameters. All X-ray crystal structures were analysed and illustrated using Mercury 4.1.0.

### Data Availability

X-ray data are available free of charge from the Cambridge Crystallographic Data Centre (https://www.ccdc.cam.ac.uk/data_request/cif) under reference numbers CCDC-2084239 ([HL][AuCl₄]) andCCDC-2084241 [HL][H₃O(H₂O)₂][CoCl₄].

### Results and Discussions

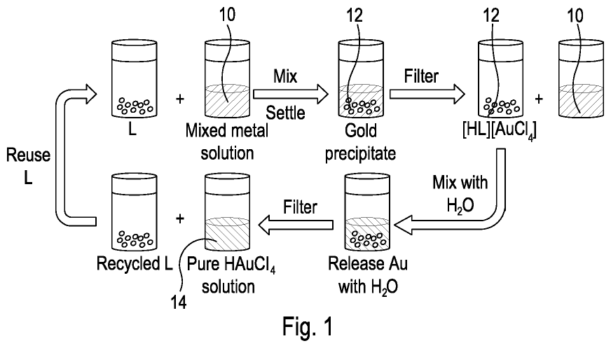

Referring to FIG. 1 there is shown a schematic representation of a selective precipitation process according to an embodiment, using compound “L” for Formula (III), according to a first embodiment.

As can be seen in FIG. 1, compound L is added to a mixed-metal solution 10, causing precipitation of a gold-containing precipitate 12. The gold-containing precipitate 12 is filtered from the solution 10. The gold-containing precipitate 12 is then washed with deionised water to retrieve gold from the precipitate 12. Filtering the resulting mixture yields an aqueous solution of gold 14, and a recycled compound L. An advantage of this approach is the ability to reuse compound L, for example to repeat the process.

Table 1 below describes precipitation experiments with Au dissolved in various aqueous matrices. Conditions: 2 mL Au solution contacted with 0.059 g L for 1 hour, room temperature. Solution filtered and diluted 100× in 2% HNO₃ prior to ICP-OES analysis. *HAuCl₄ used. **Au⁰ added to sulfuric acid solution with a few drops of 30% hydrogen peroxide added to aid dissolution of Au. All solutions were diluted 100× prior to ICP-OES analysis.

TABLE 1

| | Initial Au | Au concentration | % |
|---|---|---|---|
| | concentration | after contact with L | Pre- |
| Aqueous matrix | (mg L⁻¹) | (mg L⁻¹) | cipitated |
| 100% Aqua regia * | 1920 | 6.00 | 99.7 |
| 20% Aqua regia * | 1920 | 4.00 | 99.8 |
| 2 mol L⁻¹ H₂SO₄ and | 1940 | 12.2 | 99.4 |
| 2M NaCl ** | | | |
| 2 mol L⁻¹ H₂SO₄ and | 1930 | 9.00 | 99.5 |
| 2M NaBr ** | | | |

Table 2 below describes precipitation of HAuCl₄ by L from 2 M HCl followed by its release from L as HAuCl₄ using deionised water. All solutions were diluted 100× prior to ICP-OES analysis.

TABLE 2

| | Au | | % |
|---|---|---|---|
| | concen- | % | Stripping |
| | tration | Precipita- | (cumu- |
| Sample | (mg L⁻¹) | tion | lative) |
| 0.01M HAuCl₄ in 2M HCl (feed | 1940 | — | |
| solution) | | | |
| 2M HCl solution after contact with | 8.00 | 99.6% | |
| L | | | |
| Deionised water after contact with | 103 | — | 5.3 |
| [HL][AuCl₄] solids (2 mL) 1^{st} wash | | | |
| Deionised water after contact with | 605 | — | 36.6 |
| [HL][AuCl₄] solids (2 mL) 2^{nd} wash | | | |
| Deionised water after contact with | 826 | — | 79.3 |
| [HL][AuCl₄] solids (2 mL) 3^{rd} wash | | | |
| Deionised water after contact with | 147 | — | 86.9 |
| [HL][AuCl₄] solids (2 mL) 4^{th} wash | | | |
| Deionised water after contact with | 139 | — | 94.1 |
| [HL][AuCI₄] solids (2 mL) 5^{th} wash | | | |

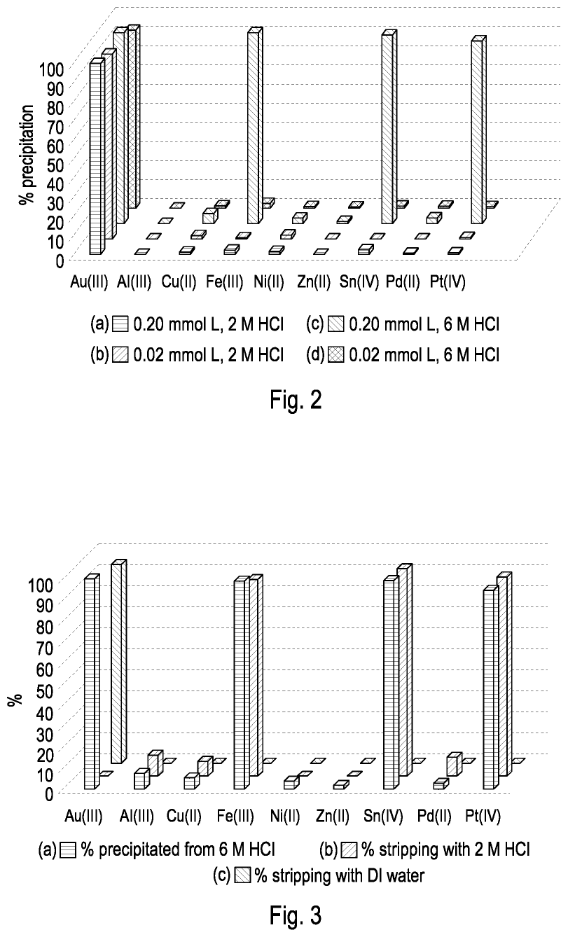

FIG. 2 is a graph showing percentage metal(s) removed by precipitation from a 0.01 M mixed-metal solution in 2 M or 6 M HCl following the addition of either 0.2 mmol of compound L (10-fold excess L relative to metal) or 0.02 mmol of L (equimolar).

The uptake of gold by L from mixtures of metals in HCl is highly selective. The addition of 0.2 mmol of solid L to a mixed-metal solution comprising 0.01 M each of Au, Al, Cu, Ni, Fe, Zn, Pt, Pd, and Sn in 2 M HCl results in near quantitative removal of Au with minimal co-precipitation of other metals (<5%, FIG. 2, (a) orange bars). It is notable that using stoichiometric L results in gold uptake only (i.e., 0.02 mmol, FIG. 2, (b) green bars) which contrasts with SX conditions where an excess of extractant is required, thus highlighting the enhanced atom economy of this precipitation method. At 6 M HCl using excess L, complete uptake of Fe, Sn, and Pt is also seen, alongside Au, from the above mixture of metals (FIG. 2, (c) blue bars), and is likely due to an increased propensity to form the chloridometalates FeCl₄⁻, SnCl₆²⁻, and PtCl₆²⁻ at higher HCl concentrations. Using stoichiometric L, however, a return to selective gold uptake is seen (FIG. 2, (d) yellow bars), which shows that a process could be designed to sequentially precipitate Au then, depending on the feed stream, Fe, Sn, or Pt. This is significant as leach solutions from gold ores (typically pyrite or arsenopyrite) are rich in iron, while those derived from e-waste have high concentrations of tin (Rao, M. D., Singh, K. K., Morrison, C. A. & Love, J. B. Challenges and opportunities in the recovery of gold from electronic waste. RSC Adv. 10, 4300-4309 (2020). Furthermore, the selectivity shown between Pt(IV) and Pd(II) at 6 M HCl is notable as this separation is integral to precious metal refining processes currently based on SX (Narita, H., Kasuya, R., Suzuki, T., Motokawa, R. & Tanaka, M. in Encyclopedia of Inorganic and Bioinorganic Chemistry, 2021, 1-28). The selectivity seen under stoichiometric conditions also suggests that the preference for gold precipitation is not wholly dependent on the ease of formation of HAuCl₄ compared with other chloridometalates, but that the chemical structures of the precipitates also define the sequence of separation (see structural analysis later).

FIG. 3 is a graph illustrating a selective metal precipitation and stripping sequence.

(a) orange bars: Percentage metal removed by precipitation from a 0.01 M mixed-metal solution in 6 M HCl.

(b) green bars: percentage of metal stripped from the precipitate by a 2 M HCl wash.

(c) blue bars: percentage of metal stripped from the precipitate after a subsequent wash with DI water.

As can be seen from FIG. 3, the selective uptake of Au at 2 M HCl compared with the requirement for 6 M HCl to load Fe, Sn and Pt permits a selective stripping process to be undertaken. As such, loading L with Au, Fe, Pt and Sn at 6 M HCl (FIG. 3, (a) orange bars), followed by a wash with 2 M HCl results in dissolution of Fe, Sn and Pt only, with Au retained on the solids (FIG. 3, (b) green bars). Washing the isolated solids with DI water releases the Au into solution and recycles L (FIG. 3, (c) blue bars).

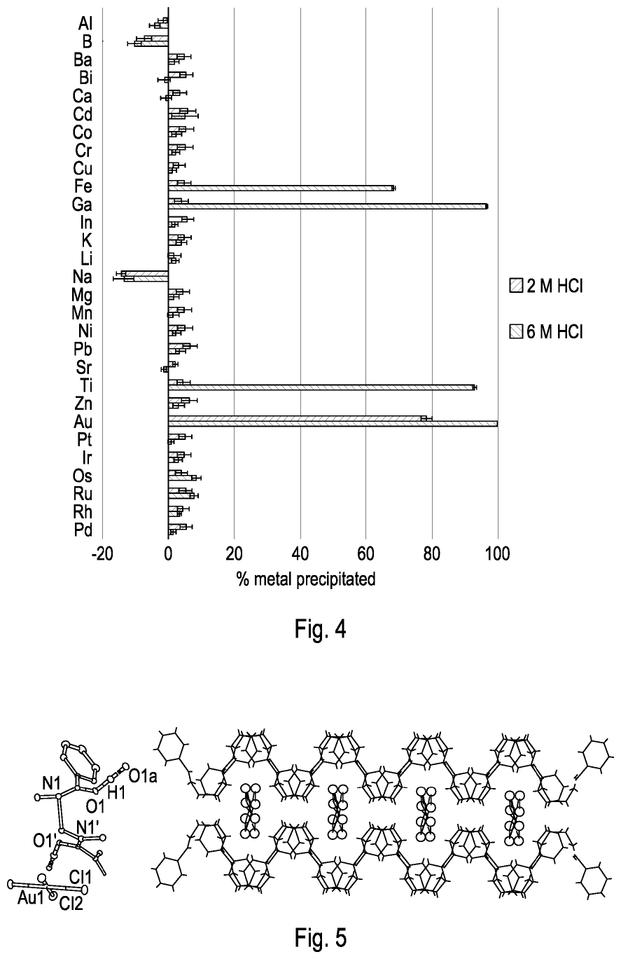

Referring now to FIG. 4, the selectivity of compound L for Au uptake was evaluated further by adding an excess to mixed-metal ICP-OES standard solutions (diluted in 2 M or 6 M HCl), comprising 29 metals at 100 or 10 ppm concentrations. Analysis of the concentrations of metals that remain in solution reveals that even in this competitive environment, L is highly selective for gold, with 70% uptake after 24 hours; thallium (at 10%) is the only other element that shows appreciable uptake at this acid concentration (FIG. 4). Raising the concentration of HCl to 6 M increases the uptake of Au to >99% but decreases selectivity, with Tl (95%), Ga (>99%), and Fe (70%) also precipitated; however, these metals could in principle be removed from the precipitate by a 2 M HCl wash (see above with reference to FIG. 3). Interestingly, no Pt uptake is seen and is due to it being present as Pt(II) (i.e., PtCl₄²⁻) and not Pt(IV) (i.e., PtCl₆²⁻), showing that the structure and charge of the chloridometalate is important to the precipitation process.

In FIG. 4, it is believed that the negative adsorption efficiencies of some of the metals above are considered to be due to contamination of the samples from elements commonly present in water and on the experimental tools.

With reference to Table 3 below, gold was selectively separated from end-of-life printed circuit boards dissolved in aqua regia (diluted to 20%), with 98% Au precipitation after 1 hour and no co-precipitation of any of the other elements present.

TABLE 3

| | Au | Cu | Ni | Pb | Sn |
|---|---|---|---|---|---|
| Sample | (mg/L) | (mg/L) | (mg/L) | (mg/L) | (mg/L) |
| Feed solution | 180 | 15400 | 105 | 818 | 1650 |
| Feed solution after | 3.45 | 15400 | 108 | 829 | 1660 |
| contact with L | | | | | |
| % metal precipitated | 98.1 | 0 | 0 | 0 | 0 |

Thus, Table 3 illustrates the selective precipitation of HAuCl₄ from a 20% aqua regia mixed-metal solution derived directly from waste printed circuit boards.

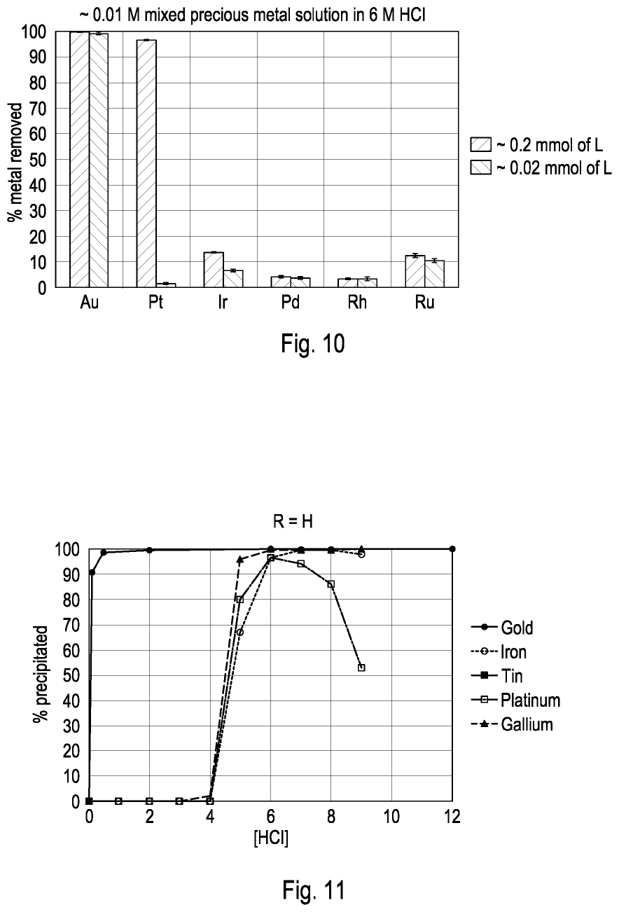

Referring to FIG. 10, there is shown a graph depicting percentage metal(s) removed by precipitation from a 0.01 M mixed-metal solution of precious metals in 6 M HCl following the addition of either 0.2 mmol of compound L (10-fold excess L relative to metal) or 0.02 mmol of L (equimolar). This graph highlights that, at equimolar amounts of compound L, selective precipitation of gold over other precious metals occurs. In addition, this graph shows that, in an excess amount of L, selective co-precipitation of gold and platinum is achieved. Therefore, in a mixture of previous metals containing gold and platinum, selective co-precipitation of gold and platinum can be achieved. In addition, if the mixture of precious metals is substantially free of gold, this graph demonstrates that it is possible to selectively separate platinum from the mixture of precious metals by using compound L in a relatively high concentration (at least 6 M) of acid (in this example, HCl).

FIG. 5 shows an X-ray crystal structure of [HL][AuCl₄] showing the intermolecular proton-chelate structure and the arrangement of the AuCl₄⁻ anions within the rhombohedral clefts derived from the phenyl and methyl substituents of the infinite chain of protonated diamides, with interactions between HL⁺ and AuCl₄⁻ of C(H)—Cl(Au) 3.43-3.97 Å; N1-C3-C3′-N1′ 54.9(3)°.

Layering a solution of 0.01 M HAuCl₄ in 2 M HCl on a 0.1 M chloroform solution of L results in controlled crystallisation. The X-ray crystal structure (FIG. 5) shows a chemical formula of [HL][AuCl₄] in which the unique proton H1 is bound between adjacent amide O-atoms O1 and O1a (O1—O1a=2.420(3) Å), forming an intermolecular proton chelate between amide units that assemble into an infinite supramolecular chain motif. While the linking of the diamides in [HL][AuCl₄] is similar to that seen for HAuCl₄ complexes of the diamidodurene R′C(O)N(R)CH₂(C₆Me₄)CH₂N(R)C(O)R′ (Shaffer, C. C. & Smith, B. D. Macrocyclic and acyclic supramolecular elements for co-precipitation of square-planar gold (iii) tetrahalide complexes. Org. Chem. Frontiers, 2021, 8, 1294-1301, (2021), the positioning of the AuCl₄⁻ anions is different. In the latter example, the π-rich aryl group interacts strongly through face-to-face π-bonding with the planar AuCl₄⁻ anion, whereas for [HL][AuCl₄] the phenyl and methyl substituents within the ribbon-like structure of the protonated diamides provide rhombohedral clefts that host the AuCl₄⁻ guest. This demonstrates the uniqueness of metal separation using the present methodology.

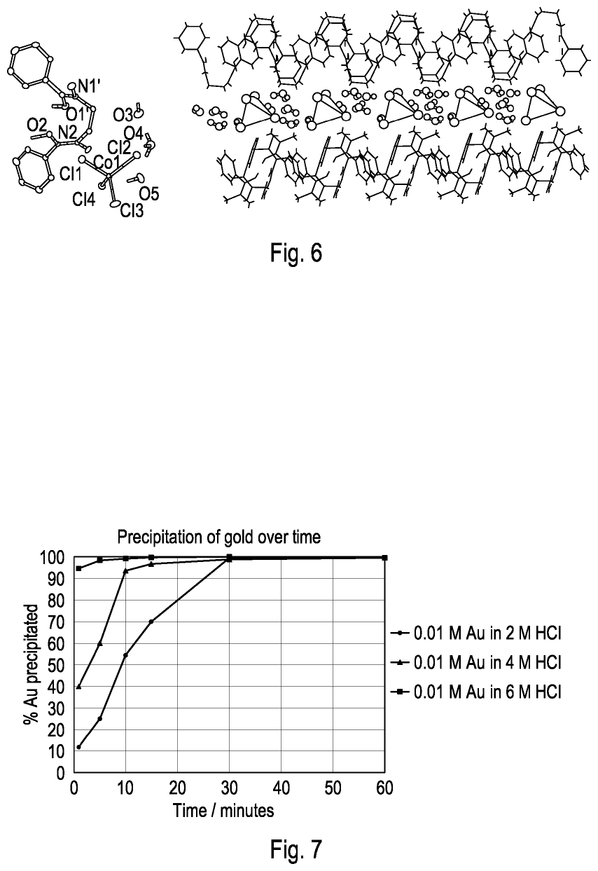

FIG. 6 shows an X-ray crystal structure of [HL][H₃O(H₂O)₂][CoCl₄] showing the intermolecular proton-chelate structure and the layered arrangement of the CoCl₄²⁻ anions and H₃O⁺ water cluster between the infinite ribbon chain of protonated diamides.

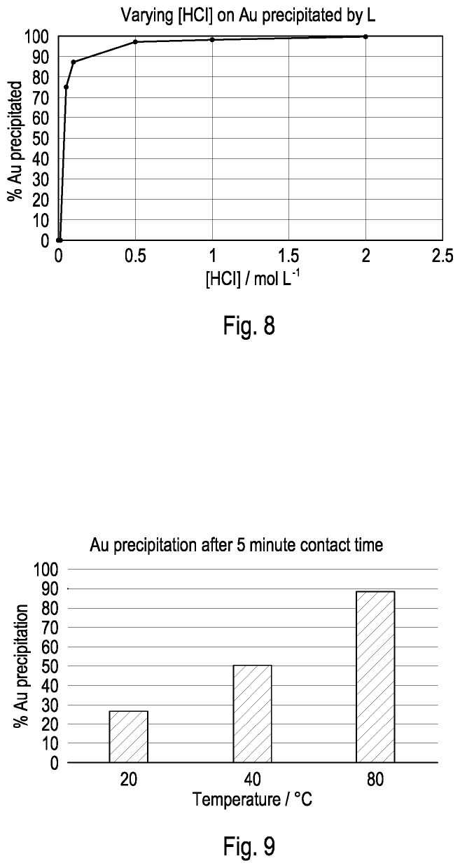

The discovery that full uptake of gold from solution occurs using a stoichiometric amount of compound L suggests that a dissolution-precipitation, not a surface-deposition mechanism, is occurring. This is supported by analysis of the rate of gold uptake at various concentrations of HCl (See FIGS. 7 and 8), which is found to be related to the extent of dissolution of L. Addition of HAuCl₄ to a solution of L in 12 M HCl results in the rapid and wholesale precipitation of [HL][AuCl₄]. Dissolution of L in 2 M HCl, as determined by quantitative ¹H NMR spectroscopy, is minimal at 0.02 μM, while heating this solution to 350 K increases the concentration of dissolved L to 0.1 μM. Increasing the concentration of HCl to 6 M results in a 16-fold increase to 0.32 μM at 300 K. The increase in dissolved L mirrors the increase in quantity of [HL][AuCl₄] precipitated from 2 M HCl over 5 minutes, which doubles on raising the temperature from 20 to 40° C. and from 40 to 80° C. (see FIG. 9).

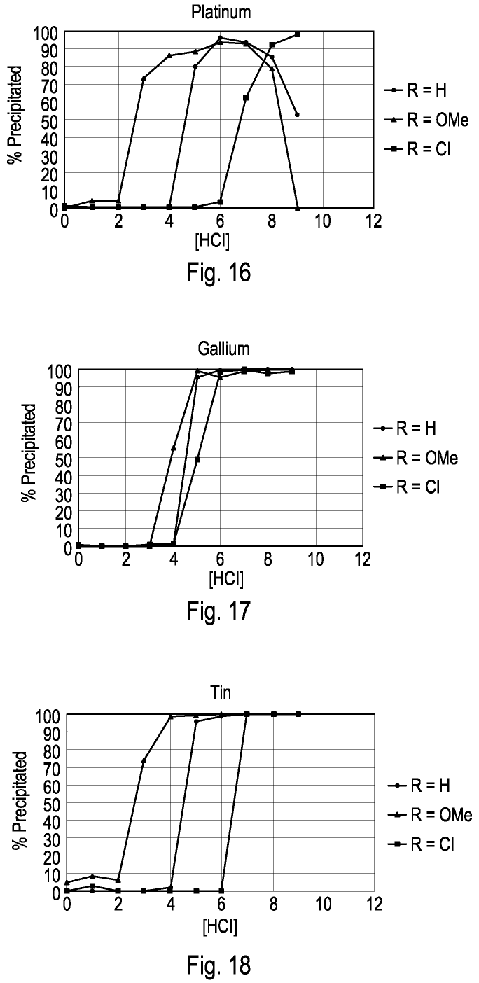

FIGS. 11-18 relates to the investigation of the effect of modifying the end group (R₁, R₂ in Formula (I)) on the precipitating behaviour of the compound according to an embodiment.

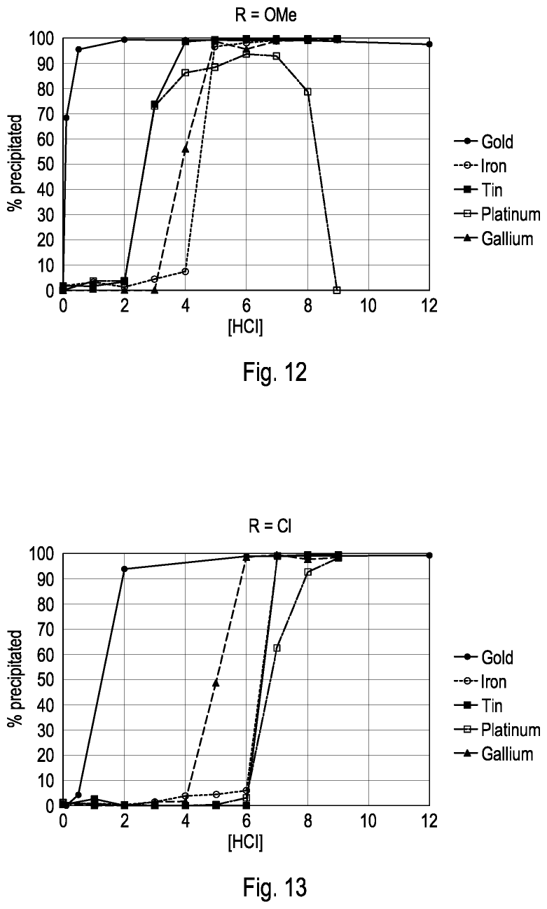

In the experiments relating to FIGS. 11-18, the compound tested was a compound of Formula (IV):

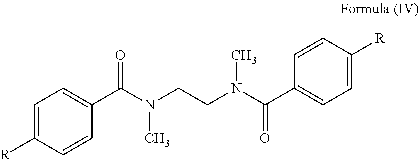

in which the “R” substituent was either H (FIG. 11), OMe (FIG. 12) or Cl (FIG. 13).

In each case, the respective graph shows the percentage of metal (gold, iron, tin, platinum or gallium) precipitated from solutions of 0.02 M metal salt at different HCl concentrations, following the addition of 0.2 mmol/L of the compound of Formula (IV) (i.e. 10-fold excess compound relative to metal).

It can be seen that, for all three compound variants, gold always precipitates a low concentration of HCl, namely from about 0.1M HCl. This is consistent with the results of FIG. 8 for compound “L”.

In addition, the selectivity of the compound, for all three variants, is shown as other metals begin to precipitate at around 3-6 M HCl.

For completeness, it will be noted that, in FIG. 11, the plot for tin was overlapped by the gallium plot. Also, in FIG. 13, the plot for iron was overlapped by the tin plot.

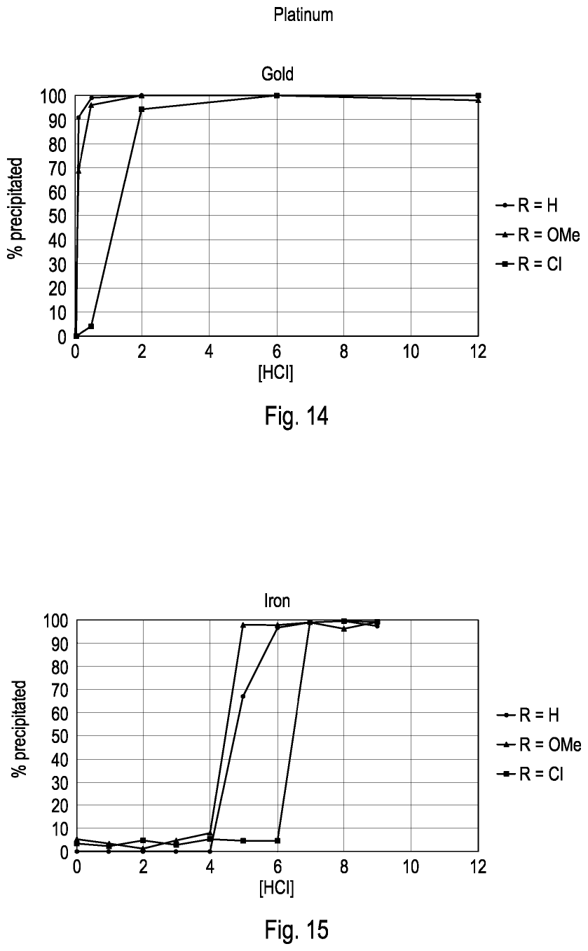

FIGS. 14-18 show similar data as the results of FIGS. 11-13, but presented for each metal (gold, iron, platinum, gallium and tin) respectively. Again, it can be seen that, for all three compound variants, gold (FIG. 14) always precipitates a low concentration of HCl, namely from about 0.1M HCl. In addition, the selectivity of the compound, for all three variants, is shown as other metals (FIGS. 15-18) begin to precipitate at around 3-6 M HCl.

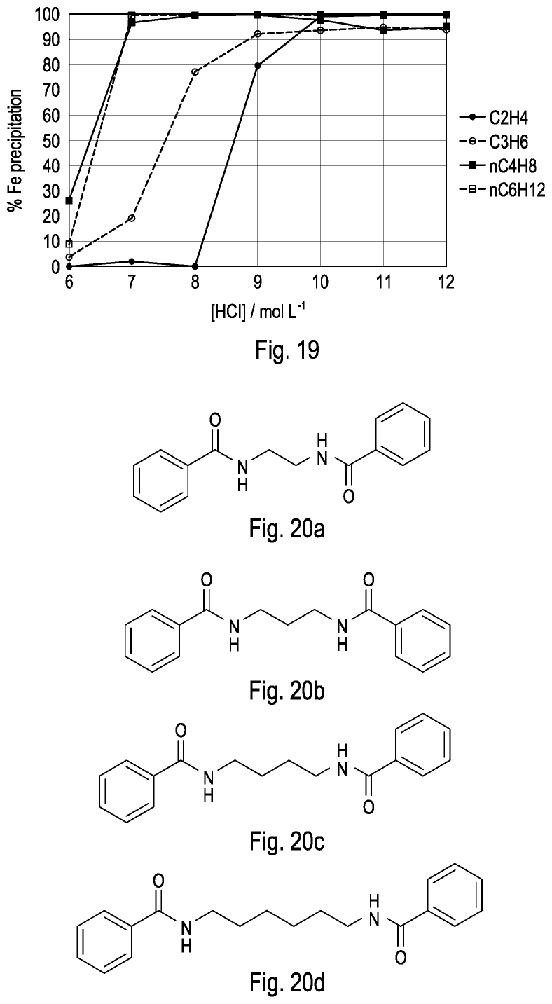

FIG. 19 is a graph showing the effect of the length of the linker group between the amide groups, on the precipitation behaviour of a solution of iron chloride. Conditions were: 0.2 mmol of compound contacted with 2 mL 0.01 M FeCl₃ in 6-12 M HCl for 24 hours at RT, 500 rpm. The plots were obtained for four variants of the linkage represented in FIG. 20.

It will be noted that the tested compound relates to a secondary diamide. In contrast to the observations made for compound “L” above, compound “L11” of FIG. 20(a) was surprisingly ineffective at precipitating iron after contacting L11 with 6 M HCl solutions for 24 hours, but precipitation was observed from about 9 M. Secondary diamides were also found to lack sufficient solubility to be effective in the present application in the selective precipitation of precious metals. The insolubility of the secondary diamides in acid is believed to be a result of strong intermolecular hydrogen bonding between NH and CO groups of adjacent amides, which is not present in tertiary amides.

As the length of the alkyl spacer is varied from 2 carbons to 6 carbons FIGS. 20(b)-20(d), Fe(III) precipitation was seen to occurs at slightly lower HCl concentrations, although still not as readily as compound “L” above.

Whilst this experiment was carried out on variants of a secondary diamide compound, the results show that varying the length of the size of the linker group between C2 and C6 does not significantly alter the precipitating behaviour of the compound, and this observation could reasonably be expected to also apply for a tertiary diamide.

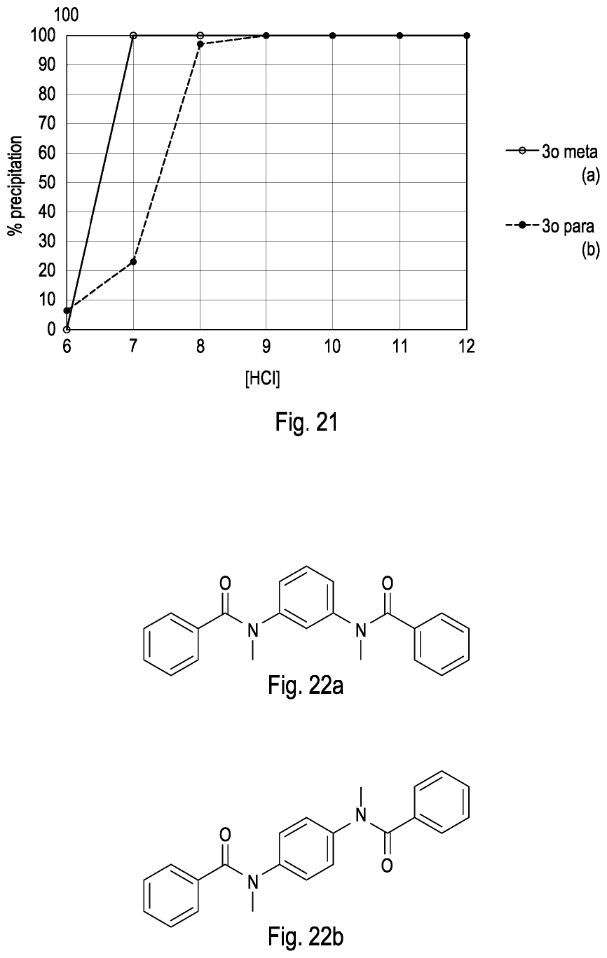

FIG. 21 is a graph showing the effect of the use of an aryl linker group between the two amide groups, on the precipitation behaviour of a solution of iron chloride. Conditions were: 0.2 mmol of compound contacted with 2 mL 0.01 M FeCl₃ in 6-12 M HCl for 24 hours at RT, 500 rpm. The plots were obtained for two variants of the phenyl linkage, as represented in FIG. 22.

The two phenyl linker derivatives at the meta (FIG. 22a) and para (FIG. 22b) positions were found to precipitate Fe(III) from 7 M HCl onwards, showing that an aromatic linker between the amide groups may be envisaged as an alternative to a C2-C6 alkyl linker.

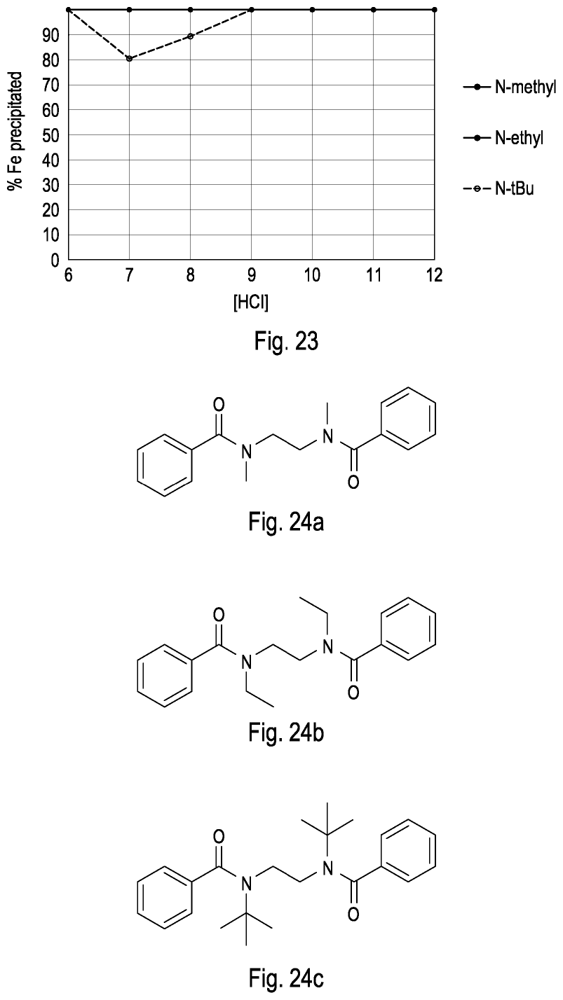

FIG. 23 is a graph showing the effect of changing the substituent group on the nitrogen atoms of the two amide groups, on the precipitation behaviour of a solution of iron chloride. Conditions were: 0.2 mmol of compound contacted with 2 mL 0.01 M FeCl₃ in 6-12 M HCl for 24 hours at RT, 500 rpm. The plots were obtained for two variants of the substituents, as represented in FIG. 24.

It can be seen that precipitation behaviour was very effective for each of methyl, ethyl, and t-butyl substituents.

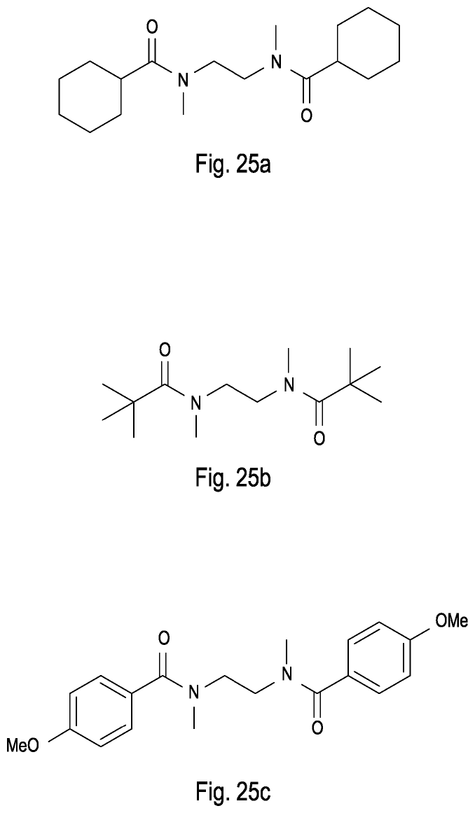

FIGS. 25(a)-(c) show alternative embodiments of the compounds that were tested. Conditions were: 0.2 mmol of compound contacted with a 2 M or 6 M HCl multi element solution for 24 hours, RT.

The solution comprised:
10 mg L⁻¹ Au, Ir, Os, Pd, Pt, Rh, Ru; and
100 mg L⁻¹ Al, B, Ba, Bi, Ca, Cd, Co, Cr, Cu, Fe, Ga, In, K, Li, Mg, Mn, Na, Ni, Pb, Sr, Tl, Zn/

For the 2 M HCl solution, it was observed that the compound of FIG. 25(a) (cyclohexyl end substituent), led to about 92% precipitation of Au, and about 94% precipitation of Tl. The compound of FIG. 25(b) (t-butyl end substituent), led to about 16% precipitation of Au, and about 96% precipitation of Tl. The compound of FIG. 25(c) (methoxy phenyl end substituent), led to about 50% precipitation of Au, and about 81% precipitation of Tl.

For the 6 M HCl solution, it was observed that the compound of FIG. 25(a) (cyclohexyl end substituent), led to about 99% precipitation of Au, Ga and Tl, and about 71% precipitation of Fe. The compound of FIG. 25 b) (t-butyl end substituent), led to about 82% precipitation of Au, 90% precipitation of Tl, 87% precipitation of Ga, and about 52% precipitation of Fe. The compound of FIG. 25(c) (methoxy phenyl end substituent), led to about 99% precipitation of Au, Tl, Ga and Fe.

Thus, the present data demonstrate the applicability of the present compounds and methodology in highly selective separation of metals by precipitation. The present method is tuneable by varying the concentration of acid, e.g., HCl, such that different metals can be selectively precipitated depending on the metal feed stream. Advantageously, the present method allows recycling of the compounds and does not rely on the use of organic solvents and may provide a simple solution towards environmentally benign metal separation and/or recycling.

It will be appreciated that the described embodiments are not meant to limit the scope of the present invention, and the present invention may be implemented using variations of the described examples.

1. A method of separating a metal from a solution, the method comprising adding to the solution a compound having a structure represented by Formula (I): 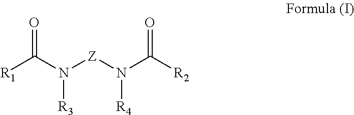
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group.

2. A method according to claim 1, wherein R₁ and/or R₂ is phenyl.

3. A method according to claim 1, wherein R₃ and/or R₄ is an unsubstituted C1-C8 alkyl group.

4. A method according to claim 1, wherein Z is —(CH₂)₂— or —(C₆H₄)—.

5. A method according to claim 1, wherein the method comprises separating the metal from the solution by precipitation.

6. A method according to claim 1, wherein the compound has a structure represented by Formula (II): 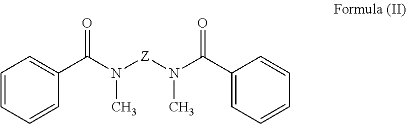
wherein Z is a C2-C6 hydrocarbyl group or an aryl group.

7. A method according to claim 1, wherein the compound has a structure represented by Formula (III):

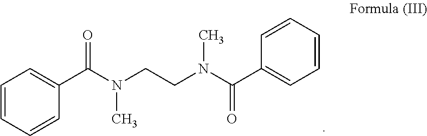 [SMILES: CN(CCN(C)C(=O)c1ccccc1)C(=O)c1ccccc1]

8. A method according to claim 1, wherein the solution comprises one or more precious metals selected from the list consisting of gold, platinum, palladium, ruthenium, rhodium, iridium and osmium, optionally wherein the solution further comprises tin and/or gallium.

9. A method according to claim 1, comprising precipitating gold, platinum, tin and/or gallium from the solution.

10. A method according to any preceding claim 1, wherein the solution is an aqueous acid solution of HCl at a concentration of about 0.1-8 M.

11. A method according to claim 1, comprising selectively precipitating gold from the solution, wherein the compound is added at a molar ratio of about 1:1 to about 1.1:1 relative to gold in the solution.

12. A method according to claim 11, wherein the method comprises adjusting the concentration of the acid in the solution, to about 0.1-4 M.

13. A method according to claim 1, comprising co-precipitating gold and platinum from the solution, wherein the concentration of the acid in the solution is at least about 6 M, and wherein the compound at added at a molar ratio in excess of 1:1 relative to gold.

14. A method of selectively separating gold from a solution containing gold and one or more other metals, the method comprising adding to the solution a compound having a structure represented by Formula (I): 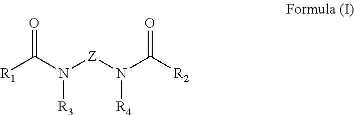
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
wherein the compound is added in a molar ratio of about 1:1 to about 1.1:1 relative to gold.

15. A method of selectively separating gold from a solution containing gold and one or more other metals, wherein the solution is an aqueous solution of a strong acid at a concentration of about 0.1-4 M,
wherein the method comprises adding to the solution a compound having a structure represented by Formula (I): 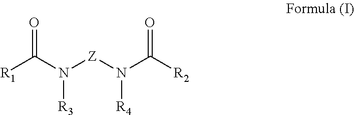
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group.

16. A method of sequentially separating gold, and one or more other metals, from a solution containing gold and one or more other metals, the method comprising:
(i) adding to the solution a compound having a structure represented by Formula (I): 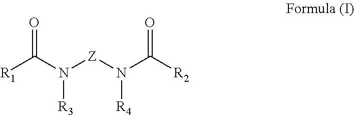
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
wherein the compound is added in a molar ratio of about 1:1 to about 1.1:1 relative to gold, so as for form a first precipitate comprising gold;
(ii) separating the first precipitate from the solution; and
(iii) adding a further amount of the compound to the solution so as to form a second precipitate comprising one or more other metals.

17. A method of sequentially separating gold, and one or more other metals, from a solution containing gold and one or more other metals, wherein the solution is an aqueous solution of a strong acid at a concentration of about 0.1-4 M, the method comprising:
(i) adding to the solution a compound having a structure represented by Formula (I): 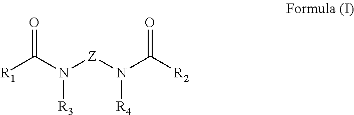
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
so as for form a first precipitate comprising gold;
(ii) separating the first precipitate from the solution; and
(iii) adjusting the concentration of the acid in the solution, to about 4-8 M, so as for form a second precipitate comprising the one or more other metals.

18. A method of sequentially separating, from an acidic solution containing gold and one or more other metals, the one or more other metals, then gold, the method comprising:
(i) adding to the solution a compound having a structure represented by Formula (I): 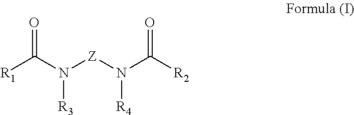
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
so as to form a co-precipitate comprising gold and one or more other metals;
(ii) washing the co-precipitate in an aqueous acidic solution so as to strip one or more other metals from the co-precipitate and yield a third precipitate; and
(iii) washing the third precipitate in deionised water so as to strip gold from the third precipitate.

19. A method of separating gold and platinum from a solution containing gold, platinum and one or more other metals, the method comprising adding to the solution a compound having a structure represented by Formula (I): 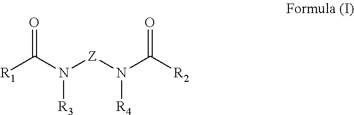
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
wherein the solution is an aqueous solution of a strong acid at a concentration of at least 6 M.

20. A method of separating platinum from a solution containing platinum and one or more other precious metals, the solution being substantially free of gold, the method comprising adding to the solution a compound having a structure represented by Formula (I): 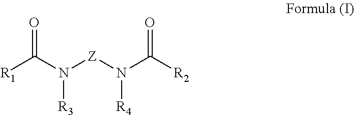
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
wherein the solution is an aqueous solution of a strong acid at a concentration of at least 6 M.

21. A method of separating tin from a solution containing tin and one or more other metals, the solution being substantially free of gold, platinum and iron, the method comprising adding to the solution a compound having a structure represented by Formula (I): 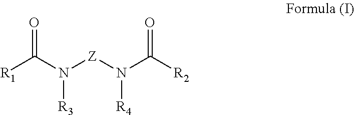
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
wherein the solution is an aqueous solution of a strong acid at a concentration of at least 6 M.

22. A method of separating gallium from a solution containing gallium and one or more other metals, the solution being substantially free of gold, platinum, iron, and tin, the method comprising adding to the solution a compound having a structure represented by Formula (I): 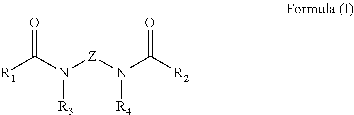
wherein:
R₁, R₂, R₃ and R₄ are each independently a substituted or unsubstituted aryl group or a substituted or unsubstituted C1-C8 hydrocarbyl group; and
Z is a C2-C6 hydrocarbyl group or an aryl group,
wherein the solution is an aqueous solution of a strong acid at a concentration of at least 6 M.
